(19) United States
(12) Patent Application Publication
(10) Pub. No.: US 2003/0198385 A1
(43) Pub. Date: Oct. 23, 2003

(54) Method apparatus for image analysis

(76) Inventors: Cameron W. Tanner, Horseheads, NY (US); Patrick D. Tepesch, Corning, NY (US)

Correspondence Address: FISH & NEAVE, 1251 AVENUE OF THE AMERICAS, 50TH FLOOR, NEW YORK, NY, 10020-1105, US

(21) Appl. No.: 09/803,133

(22) Filed: Mar. 8, 2001

Related U.S. Application Data
(60) Provisional application No. 60/188,398, filed on Mar. 10, 2000.

(51) Int. Cl. G06K 9/46; G06K 9/66; G06K 9/36

(52) U.S. Cl. 382/195; 382/284

(57) ABSTRACT

Image analysis techniques may be provided. Location of objects in an image may be determined based on intensity characteristics of pixels in the image. Objects that have been located may be mapped to a source for the objects based for example, on a grid structure that may have been used to place the objects. Differential analysis of objects of two source materials in images may be determined based on aligned versions of the images. Filtering may be used to weigh pixel characteristics. Such object analysis techniques may have been encoded into a set of machine-executable instructions and stored on a machine-readable storage medium for use by equipment that is to perform the techniques.

### CROSS-REFERENCE TO RELATED APPLICATION

This application claims the benefit of U.S. provisional patent application Serial No. 60/188,398, filed Mar. 10, 2000, which is hereby incorporated herein in its entirety.

### REFERENCE TO COMPUTER PROGRAM LISTING APPENDIX

This application includes a computer program listing appendix that is hereby incorporated herein in its entirety. The appendix is on a compact disc that includes the following files align_background.c, align_images.c, background.c, create_boxes.c, defs.h, draw_boxes.c, filters.c, find_angles.c, find_array.c, find_boxes.c, find_spots.c, free_image.c, info.c, integrate_regions .c, makefile, map_spots .c, mask. c, output_data.c, output_image.c, overlap.c, ppm.c, quality.c, read_parameters.c, read_printer_info.c, remove_overlapping_boxes.c, set_parameters.c, sort.c, spot_type.c, statisics.c, string_stuff.c, structure.h, sum_images.c, tiff.c, write_jpeg.c, write_tiff.c, wspots.c, and makefile. A c-compiler, such as the gnu-gcc computer tools, may be used to build a program with these files.

### BACKGROUND OF THE INVENTION

This invention generally relates to image analysis, and more particularly to image analysis that is automated.

Image analysis is an important tool in solving many of today's technological problems. These problems may be faced in a wide range of sciences. For example, image analysis may be involved in technologies ranging from biological sciences to electronics.

In electronics for example, there are fields, such as, circuit tracing, machine vision control, machine motion control, or radar imaging, in which image analysis may be used. In biological science for example, there are fields, such as, cellular inspection, microassays, or band identification for electrophoresis in which image analysis may be involved. Known techniques of image analysis, however, have been deficient in appropriately meeting the demands on image analysis.

For example, in biomedical or biological research and testing, known techniques have been deficient in appropriately meeting the demands involved in analyzing densely grouped spots of genetic materials, proteins, cells, etc. In such research and testing, drops of genetic materials, proteins, or cells may be placed densely on a supporting surface (e.g., a slide) to form a dense group of spots, such as a high density array. Each spot may contain a known element (e.g., molecules of DNA with a known sequence). Each spot may further include a label or tag (e.g., fluorophor, radioactive, etc.) that is used in obtaining visual expression of the known element through hybridization. On each supporting surface there may be hundreds of thousands of individual spots that are to be identified for analysis.

In some known techniques, spots in high density arrays are manually identified and analyzed by operators. Such techniques may be tedious due to the high number of spots that are involved and may include unsystematic and unpredictable errors (e.g., one operator may identify spots as being at slightly different locations on different days).

Known automated techniques have also been deficient for example, in satisfactorily meeting demands on speed, processing, accuracy, repeatability, object (e.g., spot) finding, mapping, etc.

In one known automated technique, pixels in a small simple image are searched serially to find a pixel that may have one of only two intensities. To find an island in the image, pixels may be searched recursively by searching all of the nearest neighbors and next-to-nearest neighbors of pixels that have the higher one of the two intensities when a pixel having a higher one of the two intensities is reached during serial searching. Serial searching may resume when further pixels with the higher intensity are not found. This known technique may also track which pixels have already been searched to prevent searching each pixel more than once. This technique may be deficient because it can not be applied to images having a wider range of pixel intensities, it cannot be applied to complex images quickly and accurately to locate islands, it may not meet speed and processing demands for complex images having a range of intensities, it can be inaccurate for images having a wide range of intensities, it may place a heavy burden on image analysis equipment, etc.

### SUMMARY OF THE INVENTION

In accordance with the principles of the present invention, image analysis techniques may be provided.

For object analysis, locations of objects in an image may be determined by evaluating intensity at a plurality of pixels in the image. Such techniques may sometimes be referred to as thresholding techniques. An object may be located by determining whether a current point in the slide may have an intensity that is approximately above a threshold intensity or, if desired, approximately within an intensity threshold range.

A current pixel may be determined to be part of a new object based on characteristics of two pixels that adjacent to the current pixel. A current pixel may be determined to be part of a new object when an adjacent pixel above and an adjacent pixel behind the current pixel have intensities that are not at a desired light intensity (e.g., approximately below a threshold intensity, approximately within a threshold range, etc.). An adjacent pixel behind may be a pixel that may have been examined immediately preceding the current pixel. The current pixel may be determined to be part of a known object when either an adjacent pixel above or an adjacent pixel behind have been determined to be part of an object (a known object). When an adjacent pixel above and an adjacent pixel behind have been determined to be part of two different objects, a current pixel may be determined to be part of the same object as the adjacent pixel above and the adjacent object behind may be reassigned to be part of the same object as the adjacent object above. Other pixels that may have been assigned to the same object as the adjacent pixel behind may also be reassigned. If desired, whether a current pixel, which has a desired intensity, is part of a new object or a known object may be determined based only on two of eight pixels adjacent to the current pixel (e.g., the adjacent pixel behind and the adjacent pixel above).

Pixels in an image may be evaluated in rows on a pixel-by-pixel basis. The determination of object locations may commence from a particular pixel in an image (e.g., upper-left corner, lower-left corner, etc.). Determinations of whether pixels are part of objects may be performed in parallel, in series, or in a combination thereof. If desired, for each pixel only one fourth of the pixels adjacent to that pixel may be used to determine the status of that pixel.

Pixels in an image may be searched to find a current pixel that has a desired intensity level. Searching may be performed in rows on a pixel-by-pixel basis. A current pixel may be determined to be part of a new object when the current pixel has a desired intensity level. Nearest neighboring pixels of a current pixel that has a desired intensity may be recursively searched to find other pixels that have a desired intensity. The current pixel and the nearest neighboring pixels of the current pixel that have a desired intensity may be assigned to the same object. Recursive searching may be repeated to determine a contiguous group of pixels that comprise an object. Recursive searching may involve searching in select radial directions from a current pixel having a desired intensity (e.g., searching above, below, to the left, and to the right of a current pixel).

Locations of objects may be determined by integration of intensities of pixels in a plurality of regions. Such techniques may be sometimes referred to as integration techniques. A plurality of regions of approximately a same shape may each be centered on one of a plurality of pixels in an image. The sum of intensities within each region may be determined. Intensity for each region may be associated with the pixel on which that region is centered. Intensity sums may be compared in relation to each other and a region having a highest intensity may be determined to include an object. Intensity sums for other regions that overlap a region that has been determined to include an object may be set to the lowest light intensity (e.g., zero). A region may be determined to include an object based on having the next highest intensity sum and intensity sums for regions that overlap that region may be set to the lowest intensity. Determining which region has a next highest intensity and setting intensity sums for regions that overlap that region may be repeated to find other objects on the slide. If desired, regions of approximately a same shape may be centered on substantially every pixel on a slide to determine locations of objects on the slide based on the sum of intensities in the regions.

If desired, integration techniques may be combined with thresholding techniques. For example, thresholding may be applied after integration to locate objects in an integration region, to determine characteristics of spots in an integration region, etc.

If desired, integration regions may be repositioned based on determining a center of an object in a region using thresholding techniques. If desired, thresholding techniques may be applied to determine whether to discard or ignore regions based on characteristics of objects in the regions.

Objects may be masked using an average intensity profile. A plurality of regions may have been determined to include objects. The regions may be of approximately the same shape. Pixels that are approximately in the same location in each region may be combined to determine an average intensity profile for the object shape in those regions. The average intensity profile may be normalized and applied to objects that may have approximately a same shape as the objects in the regions used in determining the average intensity profile.

Thresholding, integration, and masking techniques may be applied to automatically locate objects in an image and to locate objects in an image having pixels of a wide range of intensities (e.g., at least three levels of intensities). In particular, these techniques and their combinations may be suitable for automatically locating objects that are spots or have a periodic structure, a densely grouped structure (e.g., high density arrays), etc.

In biomedical or biological image analysis applications, the objects that are being located may be spots, such as spots in a high density array. Spots may be mapped to grid points in a grid that may have been used to place the spots on a slide for analysis. An image representative of a slide may be determined and locations of spots on the image may be determined. Positional relationship of grid points to each other in a grid may be determined. A grid may be placed on an image and moved to locate a best location at which the grid points best match the spots. The grid may be moved to maximize total intensity of spots within a distance of the grid points. Each grid point may be mapped to a nearest spot. If desired, a grid that has grid points that have been mapped to spots may be moved to minimize distances between the grid points and the spots to which grid points have been mapped. Factors, such as image skew or slide rotation, may be compensated for by determining an actual spot pitch for the spots under analysis (e.g., a horizontal spot pitch or vertical spot pitch).

A plurality of unit cell spot pitch vectors may be determined by drawing a plurality of vectors that are approximately parallel and that point approximately in the same direction from a spot to a nearest neighboring spot. Unit cell spot pitch vectors may be averaged to determine an actual spot pitch and the actual spot pitch may be used in determining a grid structure (e.g., relationship of grid points to each other). In determining the average, unit cell spot pitch vectors that do not meet certain tolerances may be excluded. If desired, pairs of spots for vectors may be determined by sorting spots based on row (or column) of the spots and selecting pairs based on where spots are located in the sorted list. If desired, an actual spot pitch for a subgrid may be determined by determining an actual spot pitch for spots that have been mapped to grid points in that subgrid.

Spots on a slide may contain material from two sources with each being tagged differently. Images that represent the slide may be generated with each image having different characteristics based on the characteristics of the tags. Spot analysis may involve locating spots in each image. Selecting one image as a reference image and aligning other image(s) to the reference image (e.g., using matrix transformation). A composite image may be generated based on the reference and aligned image(s). Locations of spots in the composite image may be determined and the locations may be used in analyzing spots on the reference image and aligned image(s).

Objects (e.g., spots) that have been located or mapped may be analyzed to obtain information about the characteristics of the objects.

Equipment for spot analysis that implements such techniques may include hardware resources (processing device, storage device, output device, scanning device, input/output device, etc.) and may include application resources (operating system, device drivers, spot array application, etc.). Spot analysis techniques may be provided for execution on a machine-readable storage medium that may include a set of instructions for performing such techniques.

### BRIEF DESCRIPTION OF THE DRAWINGS

Further features of the invention, its nature and various advantages will be more apparent from the following detailed description, taken in conjunction with the accompanying drawings in which like reference characters refer to like part throughout, and in which:

FIG. 1 is a diagram of illustrative equipment for image analysis in accordance with the present invention;

FIG. 2 is a diagram of an illustrative slide having illustrative objects thereon for image analysis in accordance with the present invention;

FIGS. 3a-3e are diagrams of an illustrative group of pixels for which thresholding techniques have been applied in accordance with the present invention;

FIG. 3f is a flow chart of illustrative steps involved in automatically locating objects in an image in accordance with the present invention;

FIGS. 4a-4f are diagrams of illustrative groups of pixels for which thresholding techniques have been applied in accordance with the present invention;

FIGS. 5a-5f are diagrams of an illustrative group of pixels for which thresholding techniques have been applied in accordance with the present invention;

FIG. 5g is a flow chart of illustrative steps involved in automatically locating spots in an image using furcation in accordance with the present invention;

FIG. 6a is a diagram of an illustrative image for which edge-rejection techniques have been applied in accordance with the present invention;

FIG. 6b is a diagram of an illustrative group of pixels for which hole-filling techniques have been applied in accordance with the present invention;

FIGS. 7a-7c are diagrams of an illustrative subsection of an image for which integration techniques have been applied in accordance with the present invention;

FIG. 8a is a flow chart of illustrative steps involved in integration techniques in accordance with the present invention;

FIG. 8b is a flow chart of illustrative steps involved in claiming which one of a plurality of regions contains an object in accordance with the present invention;

FIG. 9 is a diagram of an illustrative subsection of an image for which integration and thresholding techniques have been applied in accordance with the present invention;

FIG. 10 is a flow chart of illustrative steps involved in identifying a best object in a region in accordance with the present invention;

FIGS. 11a-11c are diagrams of an illustrative subsection of an image for which thresholding techniques have been applied to determine whether to discard a region in the image in accordance with the present invention;

FIGS. 12a-12c are diagrams of an illustrative subsection of an image for which thresholding techniques have been applied to determine whether to discard a region in the image in accordance with the present invention;

FIGS. 13a-13c are diagrams of an illustrative subsection of an image for which thresholding techniques have been applied to center a region on an object in accordance with the present invention;

FIG. 14 is a flow chart of illustrative steps involved in moving a region to center on an object in accordance with the present invention;

FIG. 15 is a diagram of an illustrative subsection of an image for which thresholding and integration techniques have been applied in accordance with the present invention;

FIG. 16 is a flow chart of illustrative steps involved in masking spots in accordance with the present invention;

FIG. 17a is a diagram of an illustrative sequence involved in determining an average intensity profile in accordance with the present invention;

FIG. 17b is a diagram of an illustrative mask that may be applied to weigh pixels in accordance with the present invention.

FIG. 18 is a flow chart of illustrative steps involved in mapping spots to grid points in accordance with the present invention;

FIG. 19 is a diagram of an illustrative image for which mapping has been applied in accordance with the present invention;

FIG. 20 is a diagram of an illustrative mapping sequence involved in mapping spots to grid points in accordance with the present invention;

FIG. 21 is a flow chart of illustrative steps involved in determining a grid structure in accordance with the present invention;

FIG. 22 is a flow chart of illustrative steps involved in determining spot-pitch vectors in accordance with the present invention;

FIGS. 23a and 23b are diagrams of illustrative spots for which spot-pitch vectors are being determined in accordance with the present invention;

FIG. 24 is a flow chart of illustrative steps involved in determining pairs of spots for determining spot-pitch vectors in accordance with the present invention.

FIG. 25 is a flow chart of illustrative steps involved in mapping based on subgrid-pitch vectors in accordance with the present invention;

FIGS. 26a and 26b is a flow chart of illustrative steps involved in determining information on two source materials in accordance to the present invention;

FIGS. 27a-27f are diagrams of an illustrative slide and illustrative images for which techniques for determining data about two different source materials have been applied in accordance with the present invention;

FIG. 29 is a cross-sectional view of a magnetic data storage medium encoded with a set of machine-executable instructions for performing the method according to the present invention; and

FIG. 30 is a cross-sectional view of an optically readable data storage medium encoded with a set of machine executable instructions for performing the method according to the present invention.

Skilled artisans will appreciate that in may cases, elements in the FIGS. are illustrated for simplicity and clarity and have not necessarily been drawn to scale. For example, the dimensions of some of the elements in certain FIGS. may be exaggerated relative to other elements to help improve understanding of what is being done.

### DETAILED DESCRIPTION OF PREFERRED EMBODIMENTS

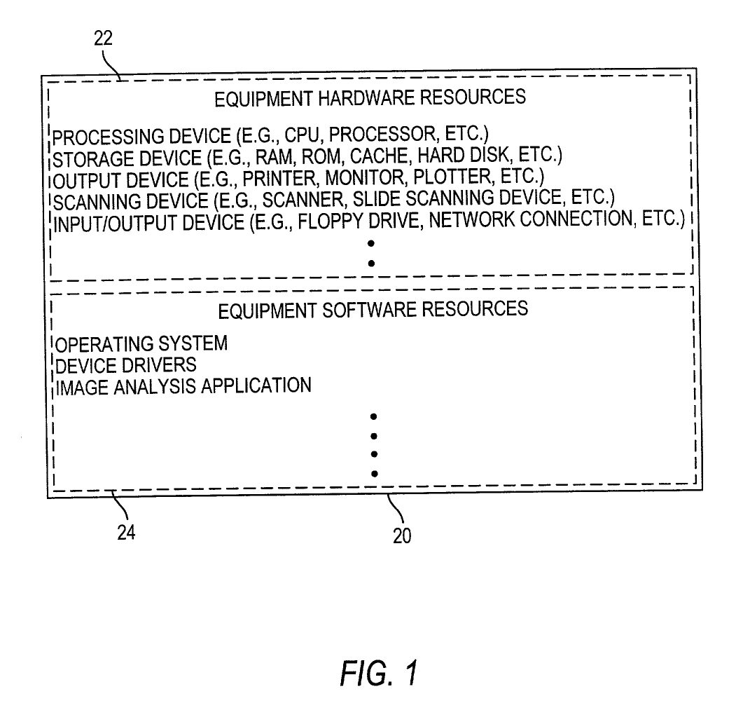

With reference now FIG. 1, equipment 20 may be used for image analysis and may include hardware resources 22 and software resources 24. Hardware resources 22 may include a processing device (e.g., a processor, CPU, etc.), storage device (e.g., RAM, ROM, disk drive, etc.), output device (e.g., printer, monitor, etc.), input/output device (e.g., floppy disk drive, network connection, etc.), scanning device (e.g., scanner, light sensing device, etc.), etc. Application resources 24 may include an operating system, device drivers, an image analysis application (e.g., image analysis application for analyzing high density arrays), etc. Together, hardware resources 22 and software resources may comprise a computer (e.g., a Sun workstation, Silicon Graphics workstation, etc.) including a scanner and a specific application for image analysis. Hardware resources 22 may have sufficient processing and storage capability to appropriately implement software resources, such as the image analysis application.

The scanning device may be a device that is configured to scan an area of interest (e.g., a biomedical or biological slide, a printed circuit board, etc.) to determine intensity characteristics of points in the area. Intensity characteristics of points in the slide may be transmissive of reflective light intensity of points in the area or may be intensity that is not based on determining light intensity such as when fluorophors or ∝-particles (radio labels) are used. The scanning device may generate data that is representative of points (e.g., intensity of points, location of points, etc.) The data may be used to generate pixels that are each representative of a point in the area of interest. Pixels may be of approximately a same shape as corresponding points that are represented by the pixels. The pixels may form an image that is representative of the area of interest.

Data from the scanning device may be used by equipment 20 in image analysis. Such data (e.g., an image of the area of interest) may be provided to equipment 20 via the input/output device of hardware resources 22. Data for image analysis may be provided to equipment 22 through sources other than the scanning devices (e.g., a network connection, storage device, etc).

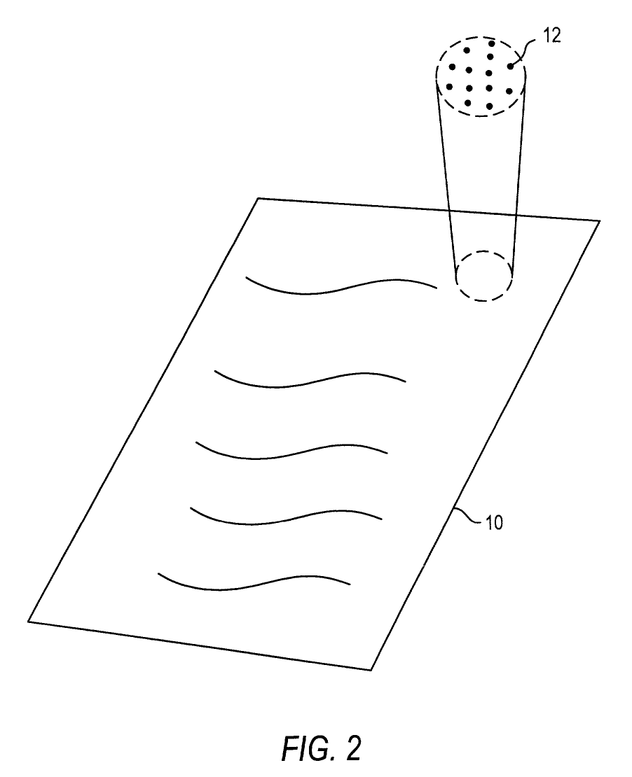

With reference now to FIG. 2, an illustrative area of interest may be slide 10 having a high density array of illustrative objects that are spots for image analysis. Slide 10 may include a periodic structure of spots. However, an area of interest may include any type of object in any pattern. Each spot 12 may include material such as genetic material, proteins, cells, etc. that have been placed in slide 10. Spots 12 may have been placed on the slide in a known pattern. The spots 12 may have been placed on the slide in approximately regularly spaced intervals (e.g., 100 micron intervals) to form a high density array. Each spot 12 may have different intensity characteristics based on the material that it contains.

Slide 10 may be scanned with a scanning device to generate data that is representative of intensities of points on slide 10. Data may have been generated in increments that are each sufficient for generating a pixel that is representative of a corresponding point on the slide. If desired, data for pixels may be generated in series, in parallel, or in a combination thereof. For clarity and brevity, the techniques discussed herein are primarily discussed in the context of pixels that are representative of points in a scanned area of interest, rather than in the context of data used to generate the pixels or in the context of the points that are represented by the pixels. Moreover, the techniques discussed herein are discussed primarily in the context of spots to aid in the clarity and brevity of the discussion and for illustrative purposes.

An image may be a grey-scale image that includes various pixel intensities.

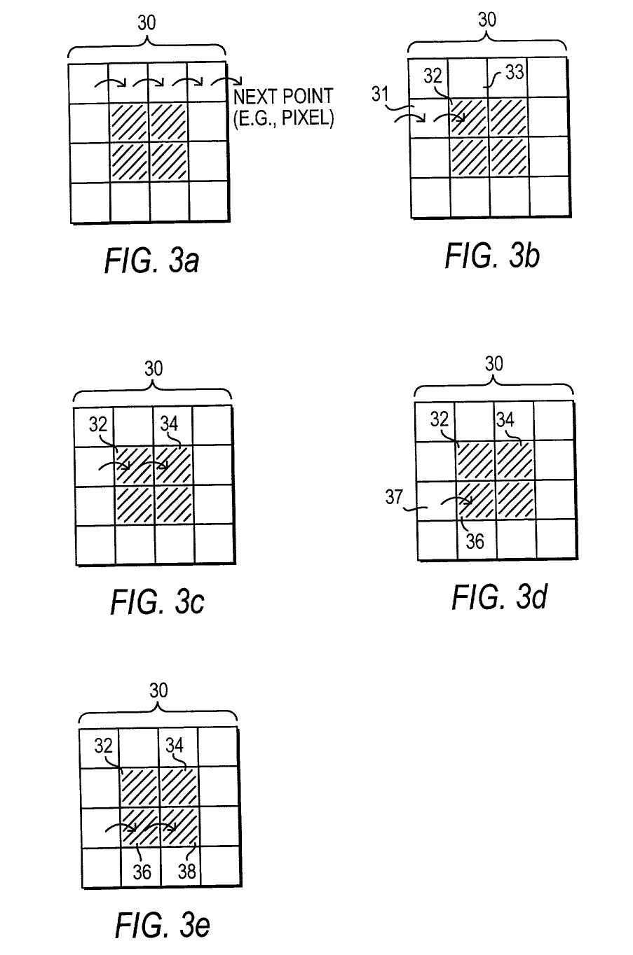

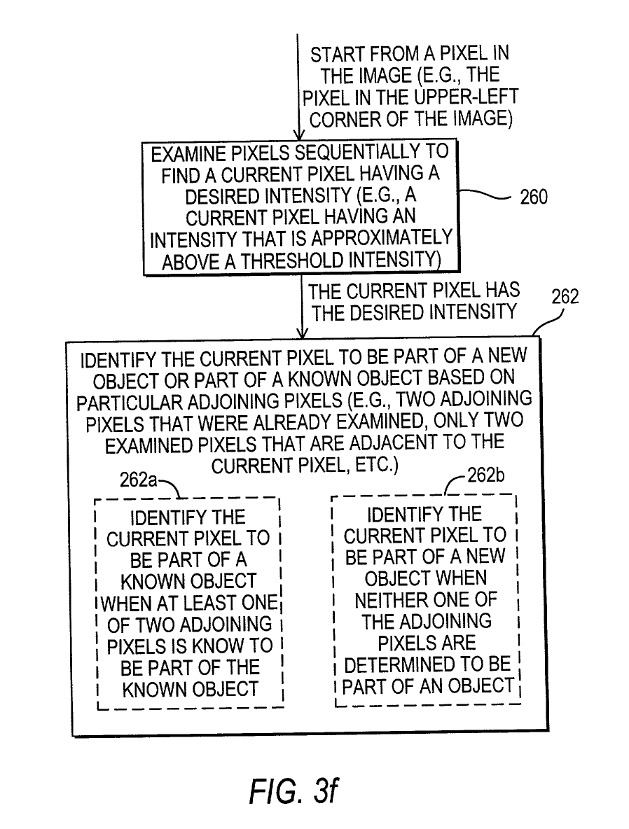

Analyzing characteristics of objects, such as spots, may involve automatically determining the locations of spots in an image. Locations of spots may be determined based on thresholding techniques. With reference now to FIG. 3A, pixels 30 may be a portion of an image that is representative of an area of interest, such as a slide having a high density array of spots thereon. Pixels 30 may be examined by spot locating equipment (e.g., equipment 20 of FIG. 1) to locate spots based on a selected threshold intensity. The equipment may start the analysis from a desired location in the image, such as from one corner of the image (e.g., top left corner). Pixels may be examined consecutively in rows walking across the image in one direction (e.g., left to right). Pixels that have intensities approximately above threshold intensity may be identified to be part of a new spot or may be identified to be part of a known spot. For example in FIG. 3A, each pixel in the first row of pixels 30 is examined in series to determine whether the intensity of a current pixel is approximately above a threshold intensity. Pixels 30 may be evaluated one at a time in a left to right direction sweeping across the image. When a row has been evaluated, the analysis of the pixels may move to the next row.

In the next row, pixel 32 that has an intensity that is approximately above the threshold may be reached and may be identified to be part of a spot. Pixel 32 may be determined to be part of a newly found spot based on adjacent pixels that have already been examined, such as the pixels above and behind pixel 32. Pixel 33 that is behind pixel 32 may be the last pixel that was examined before pixel 32. Pixel 32 may be determined to be part of a new spot when adjacent-examined pixels 31 and 33, and the pixels above and behind pixel 32, have been determined to not be part of any spots.

Pixel 34, the next pixel in that row of pixels, may be evaluated next and determined to be a part of a new or known spot based on pixel 34 having an intensity that is approximately above the threshold intensity. The status of pixel 34 may be determined by pixel 35, the pixel that is above pixel 34 (that has an intensity that is approximately below the threshold), and pixel 32, the pixel that is behind pixel 34, that was already determined to be part of a spot. Pixel 34 may then be identified to be part of the same spot as the pixel behind, pixel 32.

Pixel 36 (FIG. 3d) may be automatically identified to be part of the same spot as pixel 32 when the intensity of pixel 36 is determined to be approximately above the threshold intensity and an adjacent pixel above (pixel 32) or an adjacent pixel behind (pixel 37) has been identified to belong to a spot (e.g., the spot which pixel 32 was identified to be a part of). Such analysis may be repeated for pixel 38 (FIG. 3e). Pixel 38 may be examined and identified to have an intensity that is approximately above the threshold intensity. Pixel 38 may be determined to be part of the same spot as pixels 32, 34 and 36 because one or more of the adjacent pixels that are above and behind pixel 38 were determined to be part of that particular spot. Analysis of the image that includes pixels 30 may involve walking through the image on a pixel-by-pixel, row-by-row basis (e.g., searching for pixels with appropriate characteristics) to determine whether a current pixel has an intensity that is approximately above a threshold intensity, determine whether a current pixel having an intensity approximately above a threshold intensity has an adjacent pixel behind or above that was already determined to be part of a known spot, identifying a current pixel having an appropriate intensity to be part of the same spot as the pixel behind or above the current pixel where at least one of the pixels above or behind has an intensity that is approximately above the threshold intensity, identifying a current pixel having an appropriate intensity, an intensity approximately above a threshold intensity, to be part of a new spot when neither the pixel behind nor above the current pixel has been determined to be part of a spot, etc.

Illustrative steps involved in automatically identifying objects in an image based on pixel intensities are shown in FIG. 3f. Pixels in an image are examined sequentially (e.g., in series) starting from some yet unexamined pixel to find a current pixel that has a desired intensity at step 260. The desired intensity may be selected based on a threshold intensity (e.g., an intensity that is approximately above a selected threshold intensity for the pixels in the image). At step 262, a current pixel that has a desired intensity may be identified to be part of a new object that has not yet been identified in that image or part of a known object in that image based on particular pixels that adjoin the current pixel. The adjoining pixel may for example, be two pixels (e.g., only two pixels) that adjoin (e.g., immediately adjoin) the current pixel that have been already examined. Step 262 may include substep 262a that includes identifying the current pixel to be part of a known object based on at least one of two adjoining pixels having been determined to be part of that known object. For example, when a pixel above or a pixel behind the current pixel is part of an object, the current pixel may be identified to be part of that known object. Identifying the current pixel to be part of the object also helps to identify the areas in the image in which that object is located and helps determining characteristics of that object. Step 262 may also include substep 262b that includes identifying the current pixel to be part of a new object when neither one of two adjoining pixels were determined to be part of any objects. For example, a current pixel having a desired intensity that has a pixel above and a pixel behind that have been examined and determined not to be part of any objects may be identified to be part of a new object. This may also identify partly where that new object is located in that image. These steps may be repeated to identify other objects and to identify the pixels that are part of each of those objects. These thresholding techniques may generally be suitable for automatically identifying objects and automatically locating objects in an image. In particular, these techniques may be suitable for automatically identifying or locating objects in an image having a periodic structure or high density structure, such as a high density array of spots.

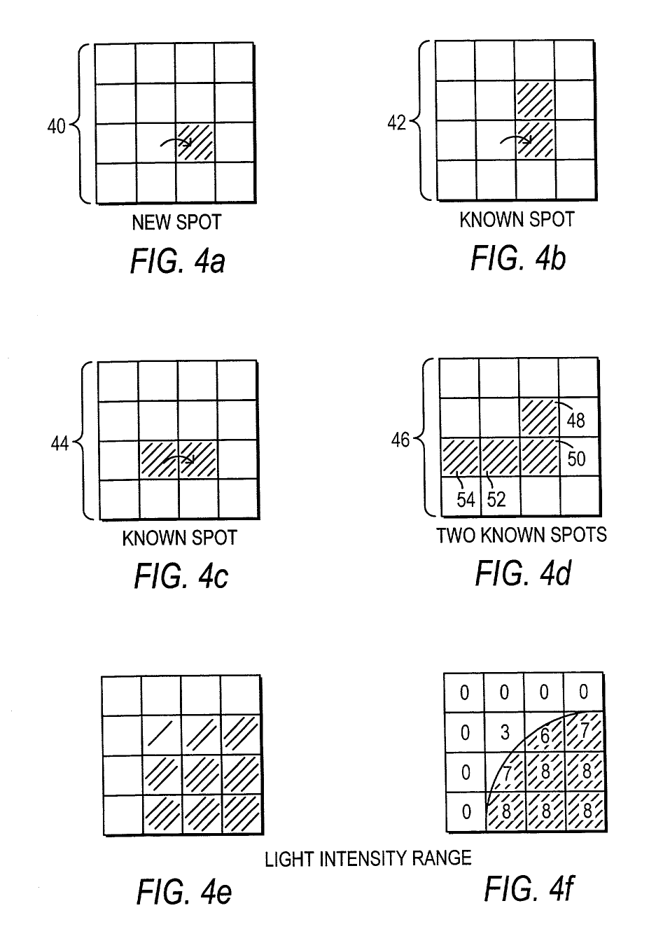

In identifying whether a current pixel is part of a new or known object, a conflict may exist between the object characteristics of adjoining pixels. For example, the pixel above may have been determined to be part of one spot and the pixel behind may have been determined to be part of another spot. With reference now to FIGS. 4a-4f, pixels 40 of FIG. 4a illustrates when a current pixel may be determined to be part of a new spot. Pixels 42 of FIG. 4b and pixels 44 of FIG. 4c illustrate when a current pixel may be determined to belong to a known spot. A conflict arises when, for example, Pixel 46 of FIG. 4b, which may be a current pixel, may be determined to equally be part of one of two known spots. In pixels 46, pixel 48, which is the pixel above pixel 50, may have been determined to be part of a first spot. The pixel behind pixel 50, pixel 52, may have been determined to be part of a second spot. The current pixel, pixel 50, may then be part of the first or second spots. One way of identifying pixel 50 may be to assign pixel 50 to the first spot and to reassign the pixel behind, pixel 52, to the first spot. Other pixels that may have been assigned to the second spot (e.g., pixel 54) may also be reassigned to the first spot. With this technique, such a conflict is resolved by identifying the current pixel and the two conflicting adjoining pixels to the same spot. Additionally, other pixels that were previously determined to be part of the same spot as one of the two conflicting pixels may be reassigned to be part of the same spot as the current pixel.

In locating spots, an intensity threshold range may be used that may provide a range of light intensities that are indicative of whether a pixel is part of a spot. For clarity and brevity, techniques discussed herein are primarily discussed in the context of a threshold intensity.

If desired, in the thresholding techniques discussed herein, pixels may be evaluated in series, in parallel or in a combination thereof.

With reference now to FIGS. 4e and 4f, pixels 41 may represent a plurality of points in an image that includes a portion of one of the spots in that image. Pixels 41 may have been assigned a value indicating an intensity for the pixel.

If desired, pixels that have intensities that are approximately below the threshold intensity or approximately outside the intensity range may be determined to be pixels that are outside of any particular spot. Thresholding techniques that involve examining two adjacent pixels of a current pixel may identify contiguous regions of pixels that identify locations of individual spots.

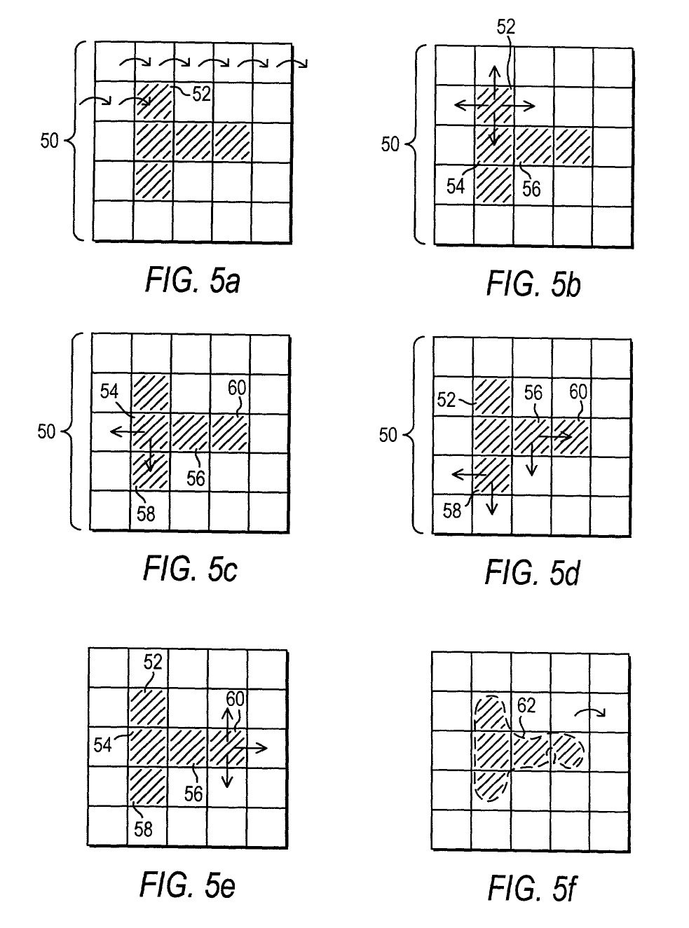

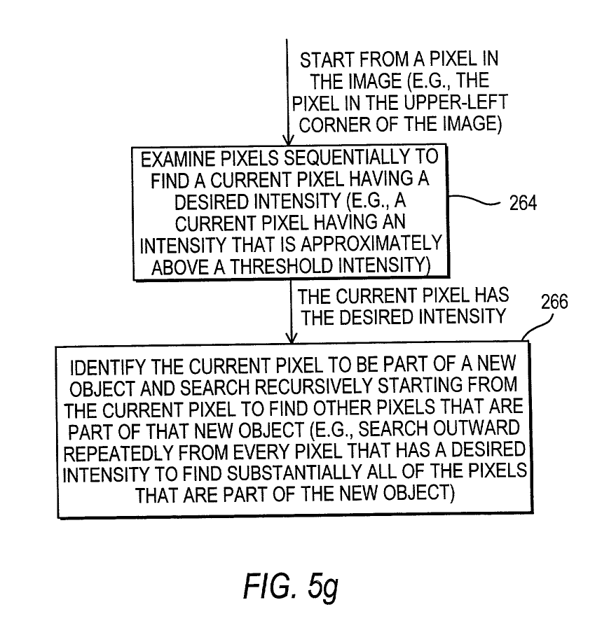

Spots may be located using recursive types of thresholding techniques. Such techniques may sometimes be referred to as furcation. Pixels 50 may be searched to locate a current pixel that has an intensity that is approximately above a threshold intensity. Pixels 50 may be searched one at a time (e.g., pixel-by-pixel). If desired, pixels may be searched in series, in rows, or in a combination thereof. As shown in FIG. 5a, pixels 50 that are in the first row may be examined in series. The examination may continue to other pixels in that row and to the next row. Searching may have commenced at the upper-left corner of the image. If desired, searching may have commenced at another point on the image. If desired, searching may be conducted is in lines of pixels or in other patterns.

When searching pixels 50, pixel 52 may be reached and determined to be part of a new spot based on pixel 52 having a desired intensity (e.g., approximately above a threshold intensity, approximately within a threshold range, etc.). Starting from pixel 52, recursive searching may be conducted. The nearest neighbors of pixel 52 may be recursively searched to find a contiguous region of pixels that are part of the new spot. Recursive searching of the pixels that are adjacent to pixel 52 (e.g., searching pixels that are adjacent to pixel 52 in a plurality of directions) may result in determining that adjacent pixel 54 has a desired intensity. Adjacent pixels of pixel 54 may be searched, searched recursively, to find other pixels that belong to that spot. If desired, searching may involve only searching pixels that have not yet been examined or searching each pixel only once. For example, as shown in FIGS. 5c and 5d, searching may involve only searching pixels that have not yet been examined. Pixels 56 and 58 may be determined to be part of that spot when pixels adjacent to pixel 54 are searched. Pixels adjacent to pixels 56 and 58 may be searched recursively to find other contiguous pixels that belong to that same spot and to identify where in that image that spot is entirely located.

Pixel 60 may be determined to be part of that spot when pixels adjacent to pixels 56 and 58 are searched. Pixels adjacent to pixel 60 may be searched recursively to find other contiguous pixels that belong to that same spot and to further identify where in that image that spot is entirely located.

Searching for neighbors of pixel 52 in a recursive pattern may cease when substantially all pixels that are contiguous with pixel 52 and that have a desired intensity have been identified (e.g., the pixels in the current spot). When recursive searching is ceased, searching of other pixels may be started in a pattern that may have been used to reach pixel 52. Recursive searching of pixels may resume when a pixel is encountered that has a desired intensity and that has not yet been assigned to be part of a spot. FIG. 5f includes spot 62 that may have been represented by pixels 52, 54, 56, 58 and 60. The rest of an image that includes pixels 50 may be searched with such techniques to locate other spots in the image. When using computers to implement such recursive techniques, an internal stack space may have to be manually created with a size that is dependent on the possible size of spots in the image.

In one embodiment of the present invention, only nearest neighbors are recursively searched. For example, as shown in FIG. 5a-5e, only the pixels that are immediately above, below, to the left, and to the right of a pixel having a desired intensity are searched. Recursive nearest neighbor searching may be performed until no new pixels that have the desired intensity are found. Searching only nearest neighbors recursively should be performed without searching next-to-nearest neighbors that would involve searching diagonally. As mentioned above, pixels that are already searched may not be searched again.

Illustrative steps involved in automatically identifying objects in an image based on recursively examining pixel intensities are shown in FIG. 5g. Pixels in an image may be examined sequentially starting from some yet unexamined pixel to find a current pixel that has a desired intensity (step 264). At step 266, a current pixel that has a desired intensity may be identified to be part of a new object that has been located. In addition, other pixels may be recursively searched starting from the current pixel to find other pixels that are part of that newly found object. For example, by recursively searching only nearest neighbors starting from the current pixel, substantially all of the pixels that are part of the new object may be identified. Recursive searching may cease when pixels that do not have a desired intensity are reached (e.g., the boundary of the object is reached). These steps may be repeated to identify other objects and to identify the pixels that are a part of each of these objects. If desired, pixels that have been searched may be tracked or another technique may be used to prevent redundant searching of pixels. For example, each pixel may be searched once at most. These thresholding techniques may generally be suitable for automatically identifying objects and automatically locating objects in an image. In particular, these techniques may be specially suitable for automatically identifying and locating objects or images having a periodic structure or high density structure, such as a high density array of spots.

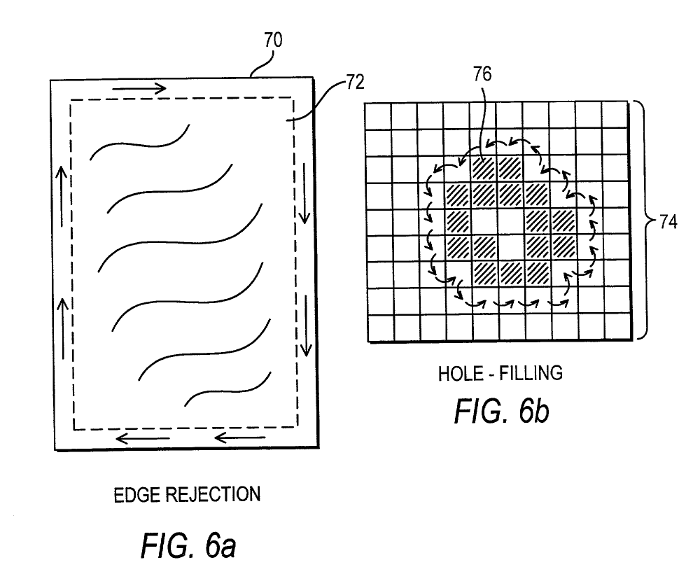

Variations in recursive searching may involve using the location of pixels to determine whether pixels are part of an object. For example, spots or pixels that are at the edges of an image may be evaluated based on their location. With references now to FIG. 6a, identifying spots may be performed by walking through the pixels along the perimeter of image 70 to find spots and then exploring interior 72. Spots that are at the edge of image 70 may be rejected. Such techniques may sometimes be referred to as edge-rejection techniques. Edge-rejection techniques may be used in combination with other image analysis techniques, such as those discussed herein.

Another variation may involve pixels that are surrounded by pixels that are part of an identified spot. For example, as shown in FIG. 6b, pixel 74 may include a region of pixels 76 that may have been determined to be part of a spot based on the intensities of pixels 76. Pixels 74 may also include three pixels that are each without a desired intensity and that are substantially within the region of pixels 76. The three pixels may be assigned to the same spot as pixels 76 based on the three pixels being substantially within pixels 76. In one such technique, the pixels along the perimeter of the region of pixels 76 may be searched to flag all pixels that are without the desired intensity. The remaining pixels, the pixels within the flagged perimeter are assigned to belong to a spot. Such techniques may sometimes be referred to as hole-filling techniques.

If desired, hole-filling techniques may be performed in combination with other spot analysis techniques, such as, those discussed herein (e.g., edge-rejection techniques).

Thresholding techniques may be used to obtain information about spots such as average radius, area, perimeter, coefficients of roundness, center of mass, average position, etc. In general, morphological properties of spots may be determined using thresholding techniques.

Techniques discussed herein may be used in ways other than with pixels or images. For example, characteristics of a plurality of points on a surface may be analyzed. A point scanning device (e.g., a device that determines intensity of points on a surface one point at a time) may be configured to automatically apply techniques discussed herein. Equipment may be used to determine locations of a plurality of points on a surface and to determine intensity characteristics for each point when applying such techniques (e.g., using furcation, hole-filling, etc.). For clarity and brevity, apparatus and methods sometimes discussed herein are discussed primarily in the context of pixels and images.

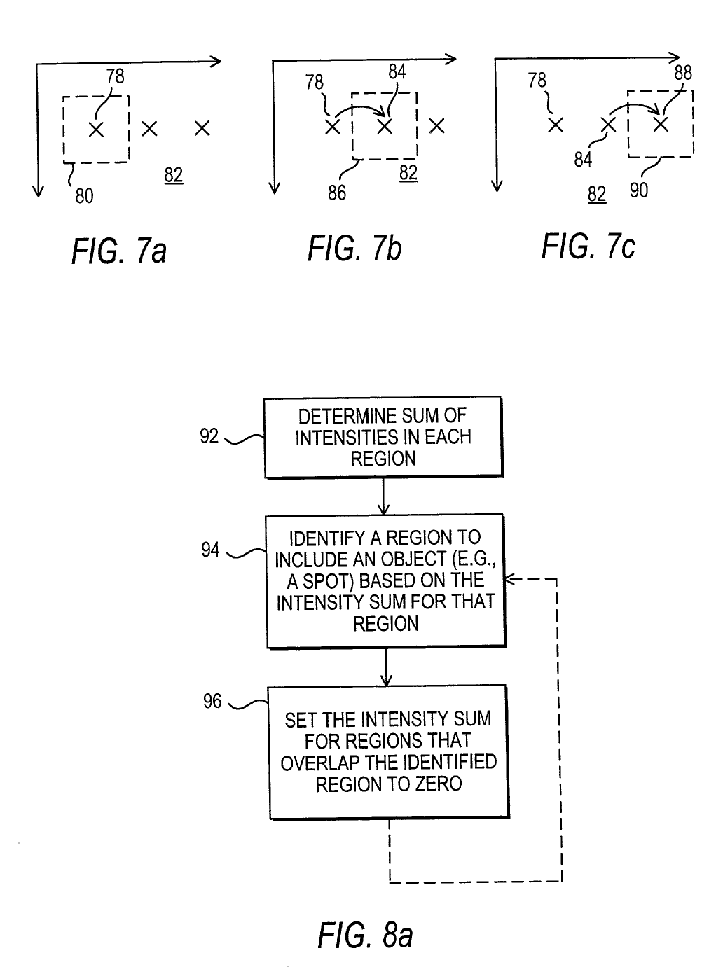

Location of objects in an image may be determined by examining a plurality of regions. For example, intensities in a plurality of regions may be used to locate spots. Such techniques may sometimes be referred to as integration techniques. For example, with reference now to FIGS. 7a-7c, pixel 78 in image 82 (a portion of image 82 is shown) may be selected and a sum of intensities for pixels in region 80 centered on pixel 78 may be determined. The region may be square in shape. If desired, other shapes may be used. The size of a region may be approximately equal to the spot pitch for spots that are in image 82. The intensity sum for region 80 may be associated with pixel 78. A next pixel, pixel 84, may be selected and a sum of intensities for pixels in region 86 centered on pixel 84 may be determined. Region 86 may be approximately the same size and shape as region 80. A third pixel, pixel 88, may be selected and a sum of intensities for pixels in region 90 centered on pixel 88 may be determined. Region 90 may be approximately the same shape and size as regions 80 and 86. Selection of pixels and summing of light intensities for regions of approximately the same shape and size centered on one of the pixels may be repeated for the rest of image 82. Distance intervals between selected pixels (e.g., pixels 78, 84, and 88) may be one pixel (e.g., pixels 78 and 84 may be adjacent, pixels 84 and 88 may be adjacent, etc.). A distance interval may sometimes be referred to as a step size. Pixels may be selected one pixel at a time in lines of pixels (e.g., rows, columns, etc.)

If desired, selection of each of a plurality of pixels may be performed in series, in parallel or in a combination of the two. Determination of sums of intensities that are each centered on one of the selected pixels may be performed in series, in parallel, or in a combination thereof.

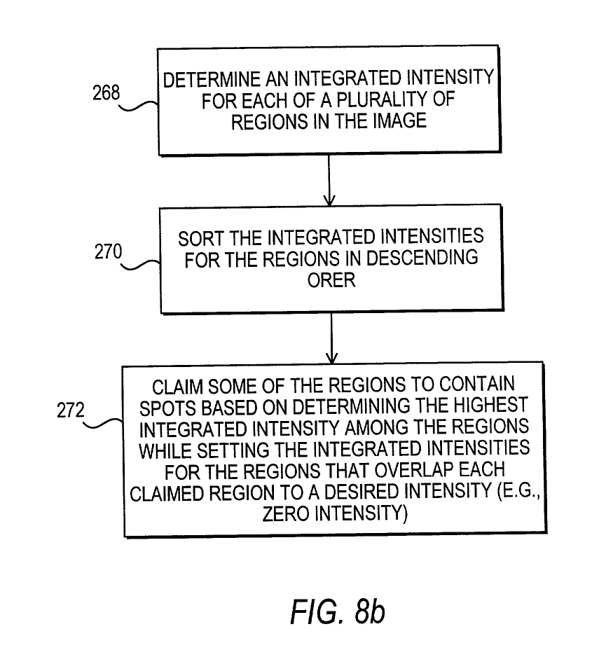

Illustrative steps involved in locating objects, such as spots, based on intensity sums of regions are shown in FIG. 8a. At step 92, the sum of pixel intensities in each of a plurality of regions may be determined. The regions may be regions such as regions 80, 86, and 90 of FIGS. 7a-7c. At step 94, one of the regions may be identified to a spot based on the sum of pixel intensities in that region (e.g., the region with the highest intensity sum may be identified to include a spot). That region may be assigned to that spot. At step 96, regions that overlap the identified region may be rejected by setting the intensity sums for the overlapping regions to zero.

Steps 94 and 96 may be repeated to locate other regions in the image that include spots (e.g., a region with the next highest light intensity sum and setting light-intensity sums for regions overlapping the assigned region to zero). If desired, steps 94 and 96 may be repeated for an entire image to locate spots in the image. These integration techniques may generally be suitable for automatically identifying or locating objects in an image. In particular, these techniques may be specially suitable for automatically identifying and locating objects in images having a periodic structure or high density structure, such as in high density arrays of spots.

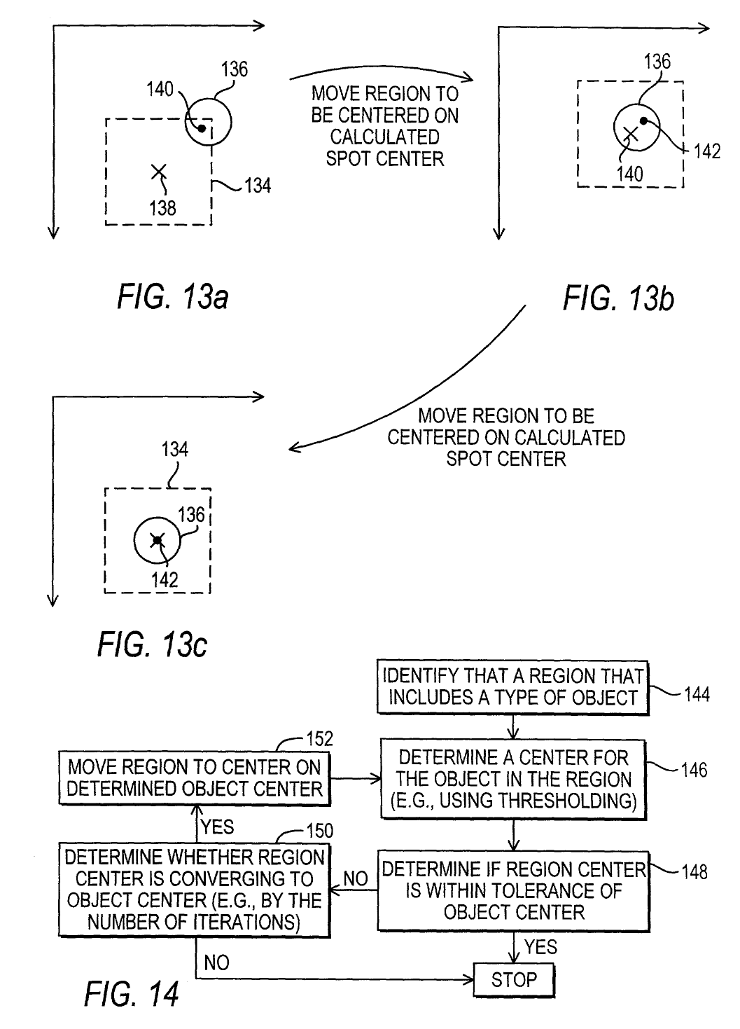

Illustrative steps involved in claiming such regions in an image to include spots based on integrated intensities (intensity sums) of regions in the image are shown in FIG. 8b. At step 268, an integrated pixel intensity for a each of a plurality of regions in an image may be determined. The integrated intensities may be determined using regions such as the regions discussed above in FIGS. 7a-7c. At step 270, the integrated intensities for the regions may be sorted in descending order. At step 272, regions may be claimed based on determining which one has the highest integrated intensity. The region with the highest integrated intensity is claimed to include a spot and the regions that overlap the claimed spot are set to zero. The claiming of the region having the highest integrated intensity while setting regions overlapping the claimed region to zero may be repeated to claim a plurality of regions to spots. The image may be analyzed further by performing the steps 268, 270, and 272, in repeated iterations, to find other spots that may have been missed in earlier iterations. Regions that were claimed in a previous iteration may be excluded from the analysis in later iterations. In one variation of this technique, before a region is claimed, the region is analyzed to determine whether the region can be centered on a spot that is in the region. Regions that can be centered are claimed. Illustrative techniques for centering are discussed below in connection with FIGS. 13a-13c and FIG. 14. Such claiming techniques may be particularly suitable for locating objects on an image when the approximate shape, size, or structural relationship (e.g., spot pitch vector) for the object are known.

One advantage of integration techniques may be the techniques' ability to handle a wide dynamic range of intensities for spots.

Thresholding and integration techniques may be combined to locate objects. Thresholding techniques may be applied to locate objects within a portion of a region used in integration techniques. The portion may have a common center with the region. A threshold light intensity or threshold range may be varied from portion to portion.

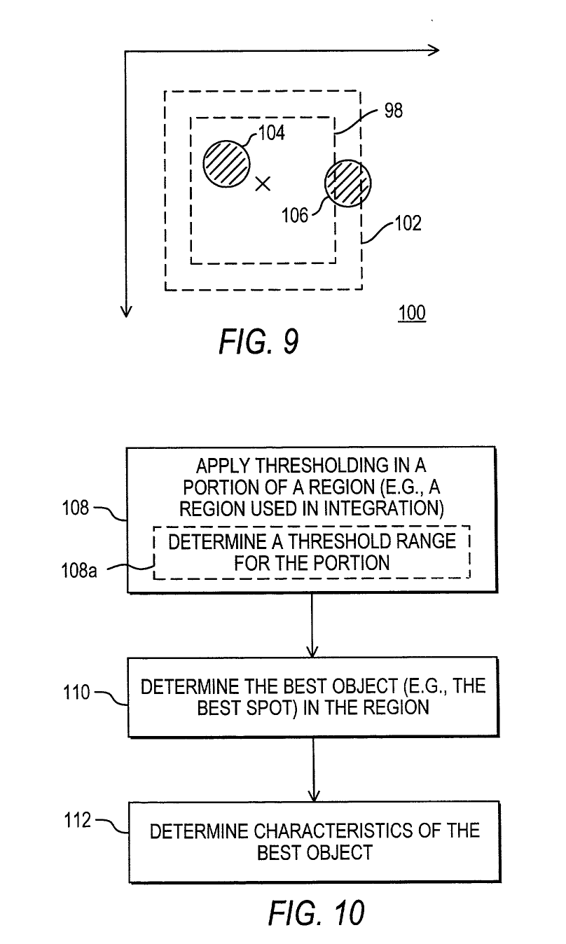

Thresholding techniques may be used with integration techniques for screening purposes. For example, with reference now to FIG. 9, portion 98 of image 100 (a subpart of image 100 is shown) may have a center that is common with the center of region 102 that may have been used in performing integration techniques. Portion 98 may be approximately the size of region 102. The size that is selected for portion 98 may be too large when spots that belong to other regions may fall within portion 98 (e.g., when portion 98 has a size that is greater than the size of region 102). The size selected for portion 98 may have been selected to be too small when portion 98 has a length or width that is smaller than a predicted diameter for the spots. A threshold range for portion 98 may be selected, for example, by selecting an average light intensity for pixels in region 102 to be the lower bound of the threshold intensity and selecting a maximum possible light intensity to be an upper bound. Spots 104 and 106 may be identified using thresholding techniques in portion 98. Properties of spots 104 and 106, such as intensity, average radius, location of spot in region, distances of spot to region center, etc., may be also determined using thresholding techniques and a best spot (e.g., spot 104) may be retained.

Illustrative steps involved in using thresholding techniques for screening purposes with integration techniques are shown in FIG. 10. At step 108, thresholding techniques may be used in a portion of a region, such as a region that may have been used in an integration technique. Step 108 may include determining a threshold range for that portion (substep 108a). Using thresholding technique, more than one contiguous group of pixels, (more than one spot) may have been determined to be in the portion. At step 110, the best object in the portion may be determined. At step 112, characteristics of the best object may be determined.

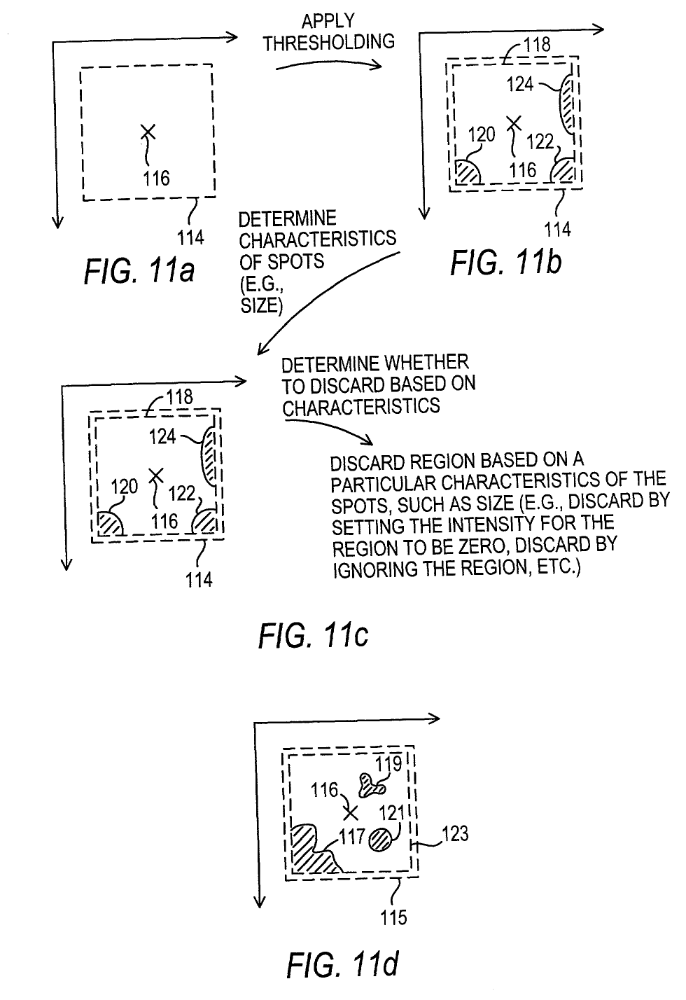

Thresholding techniques may be used with integration techniques to determine whether there are spots in an integration region that may have a size that is approximately greater than a selected minimum size. With reference now to FIGS. 11a-11c, region 114 centered on pixel 116 may have been used in determining spots using integration techniques. Thresholding techniques may be applied to portion 118 of region 116. Using thresholding techniques, spots 120, 122, and 124 may be determined to be located in portion 118. The characteristics of spots 120, 122, and 124 may be determined and whether to discard region 114 based on the determined characteristics of spots 120, 122, and 124 may be determined. Spots 120, 122, and 124 may each be determined to each have a size that is approximately below a minimum size and based on that determination, region 114 may be discarded. Region 114 may be discarded by setting intensity sum for region 114 to zero, by ignoring that region when determining which integration region has a highest light intensity (e.g., ignoring that region in step 94 of FIG. 8a), etc.

With reference now to FIG. 11d, a best spot in region 115 may be determined based on a number of criteria. Thresholding techniques may have been performed in portion 123 of region 115 to identify spots such as spot 117, spot 119, and spot 121. A best spot may be selected based on the size of the spots, how for the spots are located from center pixel 116, the shape of the spots, the locations of the spots, combinations thereof, or any other suitable criteria. For example, in FIG. 11d, spot 117 may be determined to be the best spot in region 115 based on spot 117 having a size that is greater than each of spots 119 and 121. If distance to center pixel 116 is the criteria, spot 119 may be selected to be the best spot because it the spot closest to center pixel FIG. 111b. Spot 121 may be selected to be the best spot when for example, the shape of the spots is used as the criteria for automatically selecting the best spots.

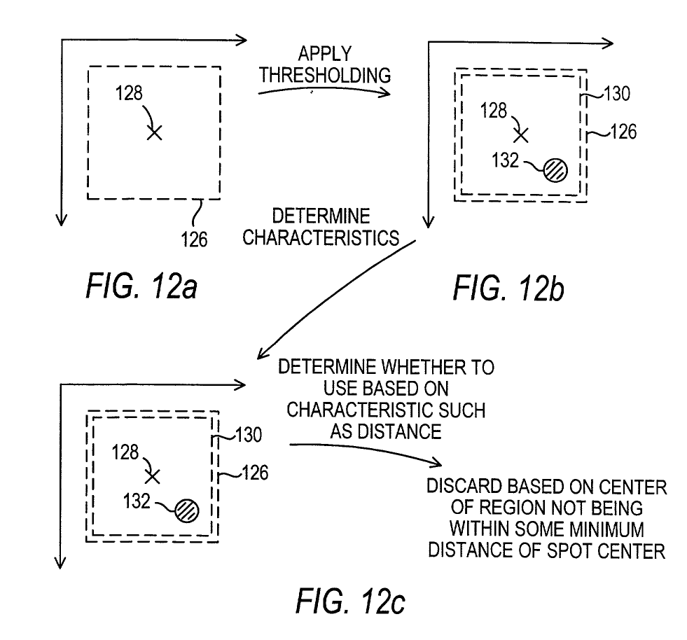

Thresholding techniques may be used with integration techniques to determine whether a spot in an integration region is approximately within a distance of the center of the integration region. With reference now to FIGS. 12a-12c, thresholding techniques may be applied in portion 130 of integration region 126 that is centered on pixel 128. Spot 132 may be determined to be located in portion 132 and characteristics of spot 132 may be determined. Characteristics may be characteristics such as, the distance within which spot 132 may be from pixel 128. If desired, when multiple spots have been determined to be located in a portion, the characteristics of the largest one of the multiple spots may be used. If desired, integration region 126 may be discarded when spot 132 is not approximately within a minimum distance (e.g., three pixels) from the center pixel, pixel 128.

If desired, thresholding techniques may be used during integration techniques, after integration techniques, or in a combination thereof.

Thresholding techniques may be used with integration techniques to center an integration region to a spot that has been determined to be located in that region. If desired, thresholding techniques may be applied after a plurality of integration regions have been identified to include spots. With reference now to FIGS. 13a-13c, region 134 centered on pixel 138 may have been determined to include a spot using integration techniques. Thresholding techniques may have been applied to determine a location of spot 136 in region 134 and to determine a center pixel 140 for spot 136. Thresholding techniques may have been applied to a portion of region 134 that is approximately the same shape and size as region 134 to determine the location of spot 136. Region 134 may be moved to be centered on center pixel 140 when center pixel 140 is not within some minimum distance of pixel 138. Thresholding techniques may be applied again to identify the pixels that are part of spot 136 and to determine a center for spot 136 in repositioned region 134 (e.g., center pixel 142). If desired, applying thresholding techniques to move region 134 may cease after this one iteration. When center pixel 142 is outside of a minimum distance from pixel 140, region 134 may be moved again to be centered on center pixel 142. Thresholding techniques may be applied to region 134 that is centered on pixel 142 to determine where spot 136 is located in region 134 and to determine whether center of spot 136 in region 134 is within a minimum distance of pixel 142. Thresholding techniques may be applied to other regions when region center pixel 142 is within a minimum distance to a spot center.

Illustrative steps involved in moving a region (e.g., as shown in FIGS. 13a-13c) are shown in FIG. 14. At step 144, a region of an image may be identified to include a type of object (e.g., that region has been assigned a spot). At step 146, a center for the object in the region may be determined (e.g., a thresholding technique may be applied to a portion of the region to determine a center of mass for the object in that region). At step 148, a minimum distance relationship between the object center and the center of the region may be determined. Additional regions may be evaluated when the distance relationship is determined to be sufficient. Whether the center of the object and of the region are converging may be evaluated when the distance relationship is not sufficient. Convergence may be evaluated by determining how many times the region may have already been moved and whether a maximum number of movements has been reached. At step 152, the region may be moved to be centered on the determined spot center in response to determining that the spot center and region center may converge. If desired, steps 146, 148, 150, and 152 may be repeated until that region has been moved a maximum number of times (e.g., object center and region center are not converging) or until object and region centers have substantially converged. Regions that may have been moved, but which may have not been determined to be converging may be discarded. Integration techniques may be applied to an image again after aligning a plurality of objects and regions to identify other regions that may include spots that were missed when integration techniques were applied.

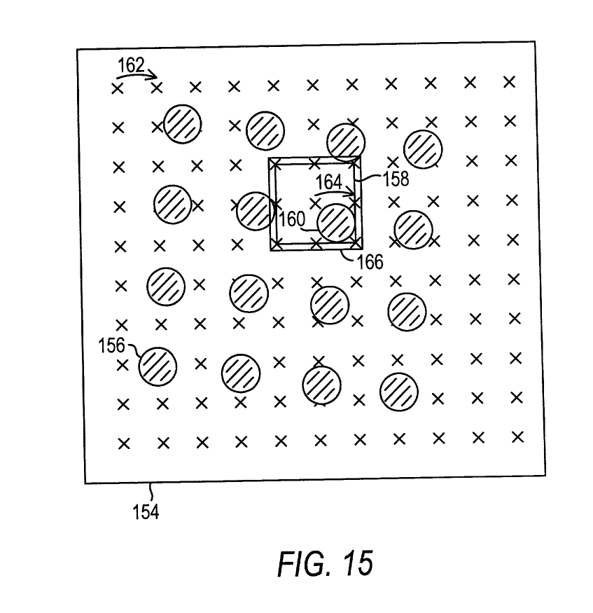

Other techniques that combine thresholding techniques and integration techniques may be used. For example, as shown in FIG. 15, image 154 (a subsection of image 154 is shown) may include a plurality of spots 156. Thresholding techniques may be applied to image portions (e.g., portion 158) that are large enough to approximately contain a nearest spot (e.g., spot 160). The approximate size of spots in the image may have been known, for example, from the techniques that may have been used to form the spots. The image may be analyzed by stepping (e.g., steps 162, 164, etc.) through a plurality of portions using step sizes that are approximately between one and one half of a spot pitch for spots that are in that image. The spot pitch may be known based on knowing how the spots were formed in an image.

A particular threshold intensity may be set for a portion based on an integrated intensity for the region (e.g., region 166) that is centered over that thresholding portion (e.g., portion 158). Portions that may have been determined to include spots may be evaluated to determine whether the portion and/or spot meet some criteria (e.g., spot size, distance to the center of portion, etc.). One criterion may be that the center of the spot found in the current portion is not approximately more than the √2* (step size)/2 pixels from the center of the current portion. A portion may be determined to include a spot (e.g., assigned to a spot) when a group of pixels in that portion has been determined to meet some criteria. If desired, portions that may overlap the portion determined to include a spot may be ignored in determining which other portions include spots. Overlapping portions may be ignored after a particular portion has been determined to include a spot, after stepping through an image, or a combination thereof.

Integration, thresholding, centering, claiming, and iteration may be combined in a number of suitable ways. For example, an image may be analyzed by using integration and thresholding to claim that particular box-shaped portions of the image include spots with appropriate properties. Thresholding techniques may be used to center the claimed boxes (e.g., using techniques described in connection with FIGS. 13a-13c and FIG. 14). Boxes that fail to be centered are rejected and boxes that are centered are retained. Claiming and centering are iterated to find other boxes that can be centered. Iterations may cease when the number of boxes that are retained is not changing.

These hybrid techniques involving thresholding and integration techniques may generally be suitable for automatic image analysis (e.g., identifying locations of objects in an image). In particular, these techniques may be suitable for automatic image analysis of periodic or high density structures, such as high density arrays.

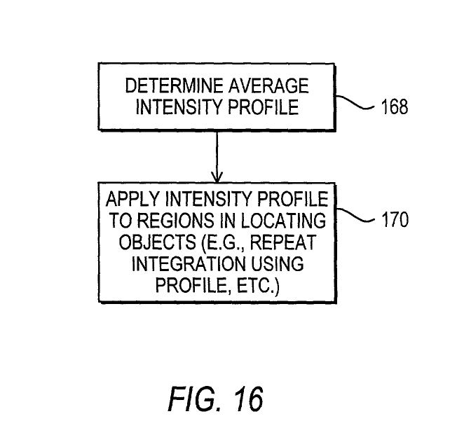

Light intensity characteristics of a spot in a current image may be used to weight spots in that image or in other images. Such weighing techniques may sometimes be referred to as masking or filtering. Illustrative steps involved in weighing are shown in FIG. 16. At step 168, an average intensity profile for objects that have been determined in an image may be determined. This gives an image of the intensity profile as a function of the average position of objects in a plurality of regions that were used in locating the objects. At step 170, the determined intensity profile may be applied in locating objects (e.g., applying profile to regions in integration techniques).

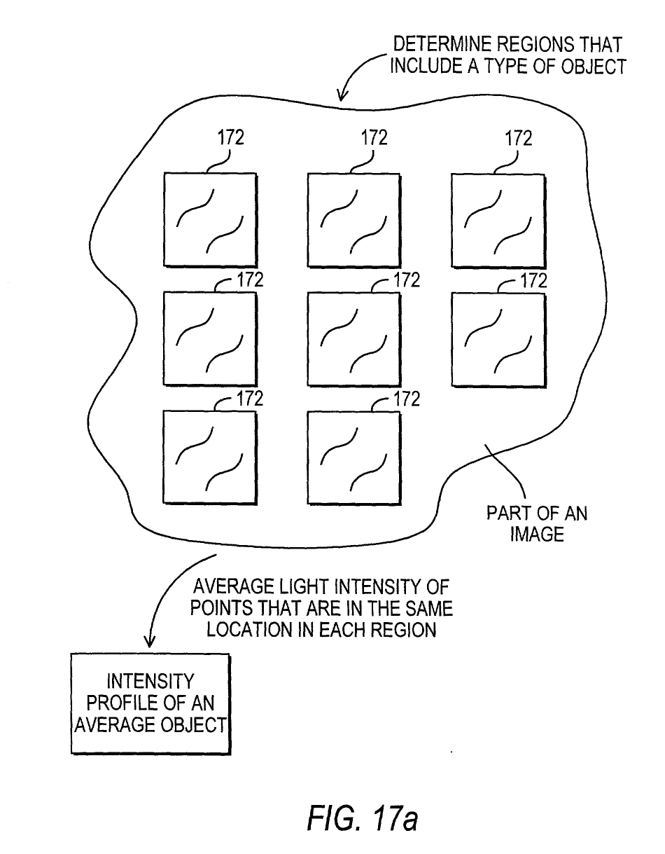

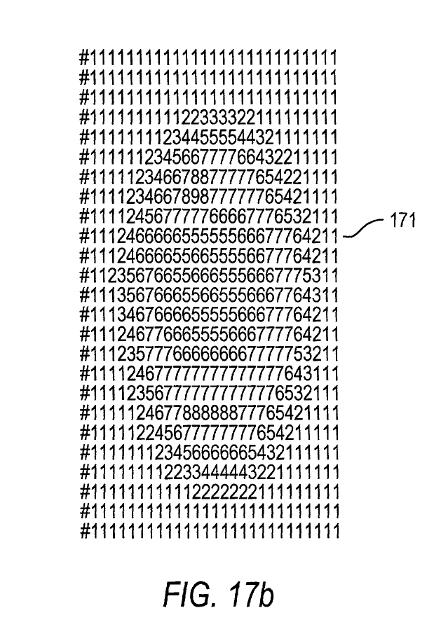

An average intensity profile may be determined using information from integration techniques. For example, as shown in FIG. 17a, integration techniques may have been applied to locate a plurality of regions (e.g., regions 172) that are determined to include spots. Regions 172 may each have approximately a same shape. Pixels that are approximately located in a same location in each region (e.g., each pixel that is in the upper left corner of each region) may be averaged to determine average intensity profile 173. The profile may indicate shape characteristics of the spots, such as whether the spots are doughnut-shaped, U-shaped, etc. Shape characteristics may be dependent on techniques used to place spots on a slide. FIG. 17b illustratively shows mask 171 that may be used in image analysis. Mask 171 may comprise weights that are associated with each pixel position in mask 171. The values of the weights may vary (e.g., from 1 to 8) at different positions in mask 171 to appropriately enhance or weaken pixels in a portion of an image for which mask 171 is applied.

The intensity profile of objects or the normalized profile of objects may be used to mask or weigh pixels in a region. The mask may be used to enhance the intensity of pixels that belong to spots and weaken those that do not. In application to integration techniques, the profile may be used to weigh the integrated region by a shape function. For example, instead of simply performing integration on the pixels in a region of interest, a shape function that is based on the profile may be used to weigh the intensity of each pixel during integration. A list of integration regions that were determined using this pixel-by-pixel weighing technique may be more likely to include objects of interest at the top of the list. An integration technique may be applied again in combination with a filtering mask (e.g., a normalized profile) to the image that was used to determine the mask. If desired, a filtering mask may be applied in applying integration techniques to other images that contain objects or structures of objects that are similar to the objects or structures in the image used to form the mask.

Such masking techniques may be generally suitable for automated image analysis. In particular, these techniques may be suitable for images having periodic or high density structures, such as high density arrays.

Thus, techniques for automatically locating objects in an image may be provided. Such techniques may be used in image analysis of objects in a variety of applications. For example, such techniques may be used to identify objects in a radar display, to analyze sonar patterns, to identify objects in aerial photographs, to chart stars, to identify cancerous cells, to differentiate cells, to trace circuits, etc.

In some biological or biomedical applications, spots containing DNA materials, proteins, cell types, etc. may be placed on a slide using techniques such as by printing spots on the slide by dipping a printing pin in a desired material and striking the slide with the pin to leave a spot of the material on the slide. A plurality of pins may be operating (e.g., using robotics) in parallel to place spots in a grid at a plurality of grid points to form a high density array of spots on a slide. Each pin may be used to furnish a subgrid of a high density array (e.g., using one pin to fill a subgrid).

Points in a grid that were used to place a high density array of spots on a slide may primarily be discussed in the context of grid points. Slides may include points that may be evaluated to determine locations of spots on the slide. Such points, points on a slide, may be primarily discussed in the context of the term points to differentiate points or a slide, slide points, from grid points.

Each grid point may be used to place a spot that contains a different material. Spots, which have been automatically located may be mapped to (e.g., matched with) grid points that were used to place the spots. After mapping, each spot may be indexed based on row and column of the spot in a high density spot array and based on the row and column of the printing pin that may have been used to print that spot. Locations of grid points may be used to locate spots in the image. For example, after mapping, thresholding techniques may be applied to an area at the position of an empty grid point to find a missing spot.

Mapping may be performed based on the structure of the grid used to place the spots (e.g., the relationship of the grid point to each other). The structure of the grid may be determined based on spot pitch, pin pitch, and number of spot and pin rows and columns for the current high density array under analysis.

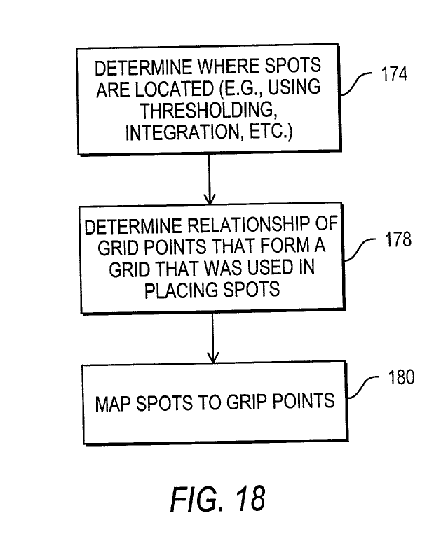

Illustrative steps involved in mapping spots to grid points are shown in FIG. 18. At step 174, areas in an image may be identified to include spots (e.g., by using thresholding techniques, integration techniques, etc.). At step 178, a structural relationship for grid points in a grid that was used to fill a high density array of spots may be determined. At step 180, spots may be mapped to appropriate grid points.

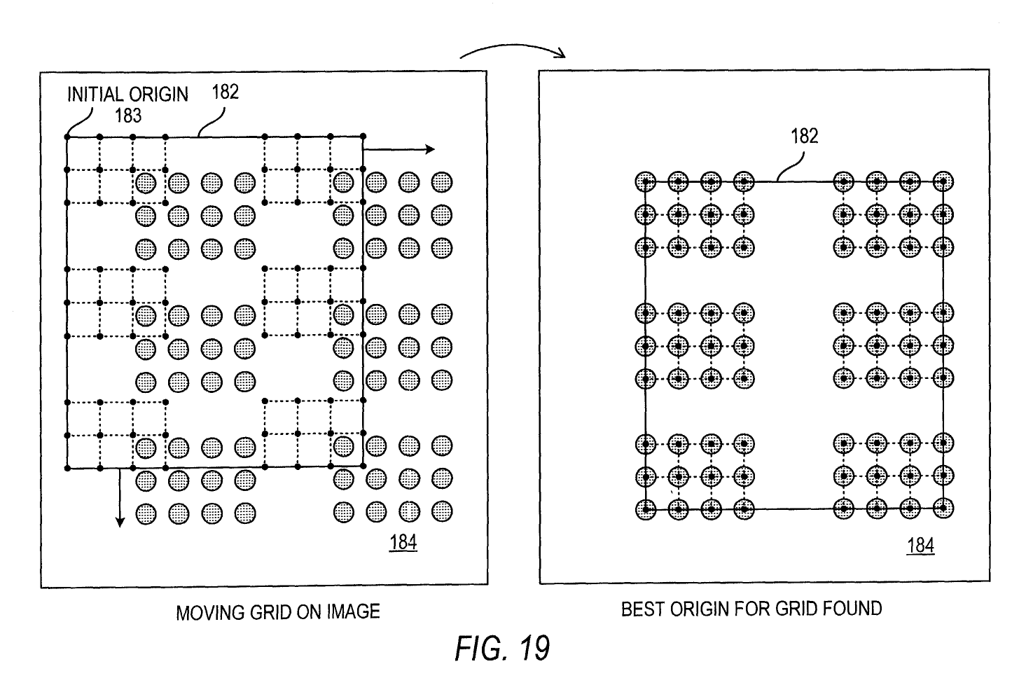

With reference to FIG. 19, grid 182 may be placed on image 184 (a part of which is shown) for spot mapping. Placing grid 182 on image 184 may involve selecting an origin for grid 182 on image 184. A best origin may be found by moving grid 182 within the bounds of image 184 to test possible origin pixels (e.g., from initial origin pixel 183).

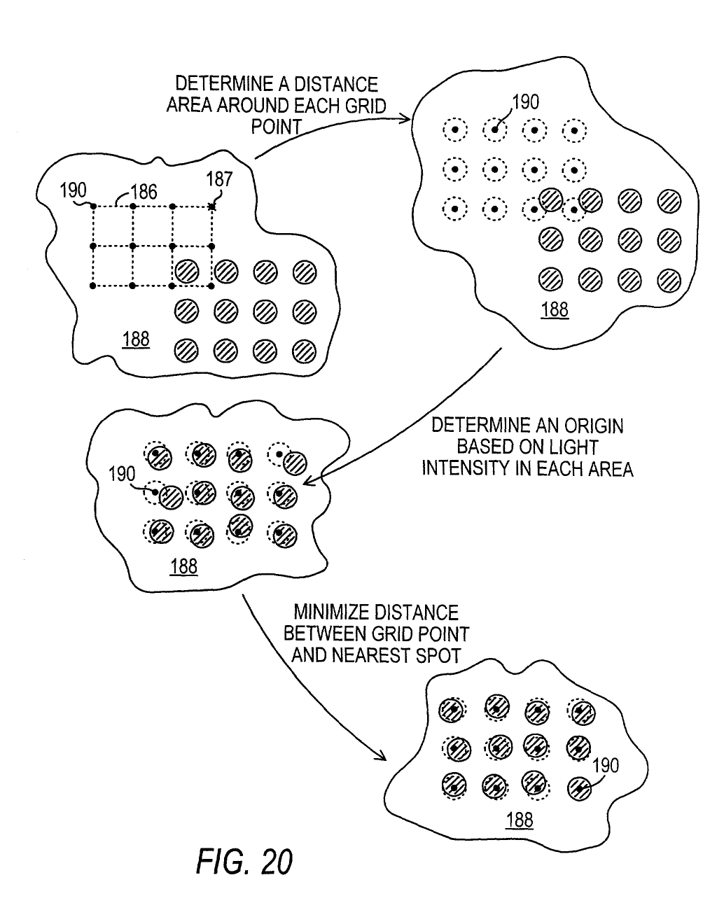

A best origin may be determined based on light intensity of spots, distance between grid points and spots, etc. For example, with reference now to FIG. 20, grid 186, which may be part of a larger grid, may be placed on image 188, which may be part of larger image, at initial test origin pixel 187. Image 188 may include a plurality of spots. Grid 186 may include grid points 190. Areas that lie within a specific distance of each grid point 190 may be identified (e.g., a circle surrounding each grid point 190 with a radius having a specified length). Test pixels may be used to find a best origin for grid 186 based on maximizing intensity of spots that are within the specified distance from exchange of grid points 190. Each spot may be assigned to a nearest grid point when a best origin has been determined. Extraneous spots may be ignored.

A best origin may be determined based on the distance between spots and grid points. Grid 186 may be moved based on minimizing distances between each one of grid points 190 and the spot assigned to that grid point.

If desired, mapping may be further adjusted pin-by-pin, subgrid-by-subgrid, etc. A best origin for each grid point may be determined by moving the location of the grid point to maximize total intensity in an area within a certain distance of the grid point. If desired, a best origin for each gird point may be determined by moving the location of the grid point on the image to minimize the distance between the grid point and a spot that has been assigned to the grid point.

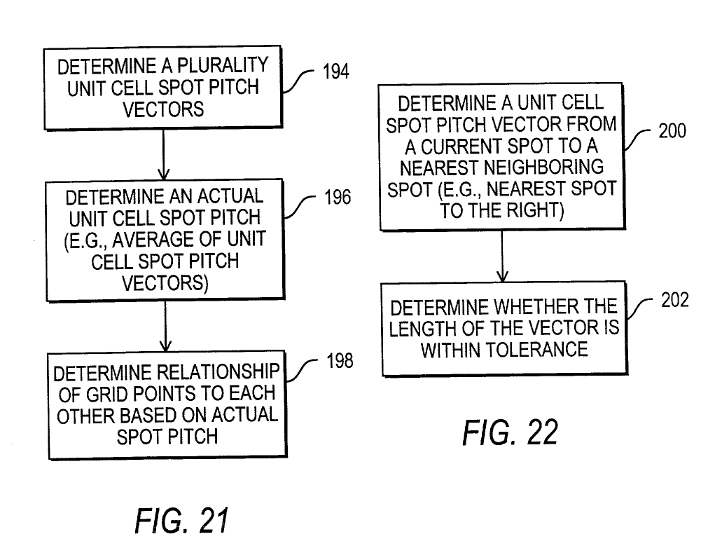

An actual spot pitch for spots in a high density spot array of an image may be determined. Actual spot pitch may be determined to compensate for such things as image skew, slide rotation, rattle of printing pins, variable motion of printer, etc. Illustrative steps involved in determining a printing grid structure are shown in FIG. 21. At step 14, a plurality of unit cell spot pitch vectors may be determined. For example, a plurality of vectors may be determined using plural pairs of nearest neighboring spots. The vectors may be approximately pointing in the same direction. At step 196, an actual unit cell spot pitch may be determined. The actual spot pitch may be determined by averaging the plurality of unit cell spot pitch vectors. At step 198, a grid structure may be determined based on the actual spot pitch. The actual spot pitch may be used to determine the positional relationship of grid points to each other.

Illustrative steps involved in determining unit cell spot pitch vectors for determining actual spot pitch are shown in FIG. 22. At step 200, a unit cell spot pitch vector may be provided by determining a vector from a current spot to a nearest neighboring spot (e.g., the nearest neighboring spot to the right). At step 202, the length of the vector may be determined to determine whether the vector meets a desired tolerance.

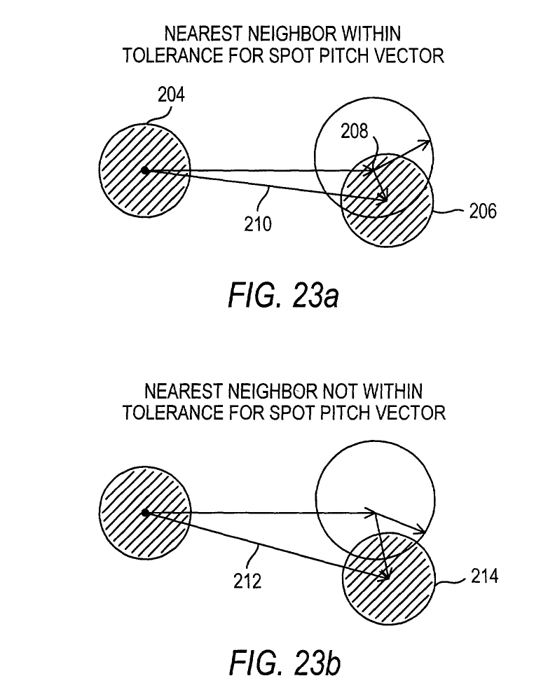

Tolerance for spot pitch vectors may be determined based on distance. For example, as shown in FIGS. 23a and 23b, a spot pitch vector may be selected to be used in determining an actual spot pitch when a nearest neighboring spot is within a distance of a predicted location for that spot. With reference now to FIG. 23a, current spot 209 may have nearest neighboring spot 206 that is to the right of current spot 204. Based on a predicted spot pitch, spot 206 may have been predicted to be centered on pixel 208. A particular distance tolerance for variation in location of a predicted spot location and an actual spot location may have been selected. For example, the center of spot 206 may have to be within a spot radius of pixel 208. Unit spot pitch vector 210 may be used in determining an actual spot pitch based on the center of spot 206 being approximately within a spot radius of pixel 208. With reference now to FIG. 23b, unit cell spot pitch vector 212 may not be used based on spot 214 being approximately outside a desired distance from a predicted center for spot 214.

To obtain an actual horizontal spot pitch, a nearest neighboring spot to the right of each spot may be located. Vectors connecting pairs of spots (each spot connected to a nearest neighboring spot to the right) may be located. Vectors that meet a distance tolerance may be averaged to obtain an actual horizontal spot pitch. If desired, vectors that deviate beyond a particular tolerance in the vertical direction may be excluded from the calculation. The actual horizontal spot pitch may be written as aₓ î+a_{y} ĵ. Similarly, an actual vertical spot pitch vector may be obtained by averaging vectors between each spot and the nearest neighboring spot below. Vectors that do not meet a distance tolerance or vary beyond a particular tolerance in the horizontal direction may be excluded from the average. An actual vertical spot pitch may be written as bₓ î+b_{y} ĵ.

Iterative techniques may be used to determine a spot pitch vector. For example, a determined spot pitch vector may be used to prime another determination of the spot pitch vector. A determined spot vector may be used in a next iteration to set the tolerance used in determining which spot pitch vectors are averaged and which are discarded. If desired, iterations may continue until converging or until a maximum number is reached.

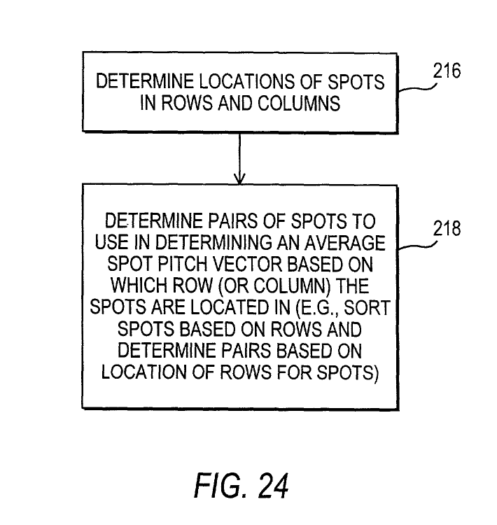

Pairing spots in determining unit cell spot pitch vectors may be determined based on which rows (or columns) spots are located. Illustrative steps involved in pairing spots based on row (or column) are shown in FIG. 24. At step 216, row and column locations of spots in a high density array in an image may be determined. The spots may be sorted based on row or column position. At step 218, pairs of spots for determining actual spot pitch may be determined by eliminating pairs based on row (or column) positions of the spots (e.g., spots that are more than one row apart are not paired). If desired, spot pairs that have appropriate row (or column) criteria may be further evaluated based on a distance tolerance (as discussed above).

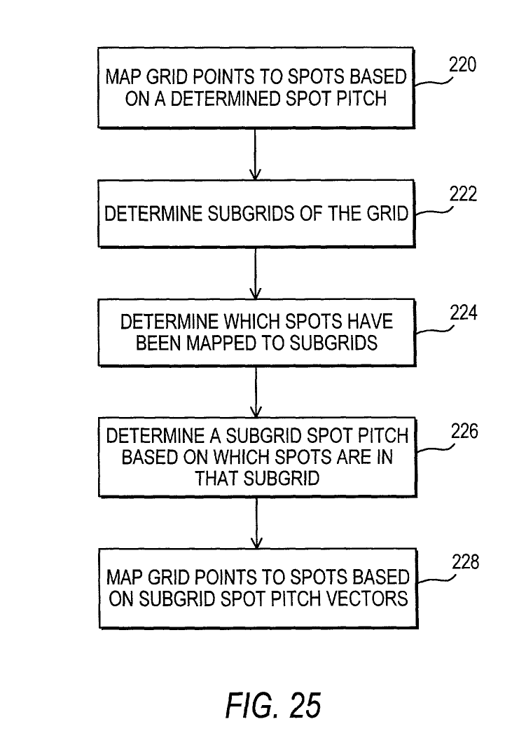

In some known spot printing techniques, a subgrid of spots may be printed in one strike of a printing head. The printing head may have a plurality of pins arranged in a subgrid. Illustrative steps involved in mapping spots to a subgrid that was used to place the spots (e.g., place the spots in one strike) are shown in FIG. 25. At step 220, grid points may be mapped to spots based on a spot pitch (e.g., an actual spot pitch). At step 222, subgrids in the grid may be identified. At step 229, spots that have been mapped to subgrids may be determined. At step 226, a subgrid spot pitch may be determined for the subgrids based on the spots that are in the subgrids. At step 228, spots may be remapped to grid points based on spot pitches for the subgrids.

One known use of high density spot arrays may involve hybridization of DNA from at least two different sources, such as normal lung tissue and cancerous lung tissue on the same high density array. DNA from each source may be tagged, for example, with a different fluorescent molecule so that differential expressions are observable through light intensity. An image may be generated from a slide for each fluorescent tag/tissue type on the slide. Analysis of expression may involve gathering data from approximately a same position in each slide.

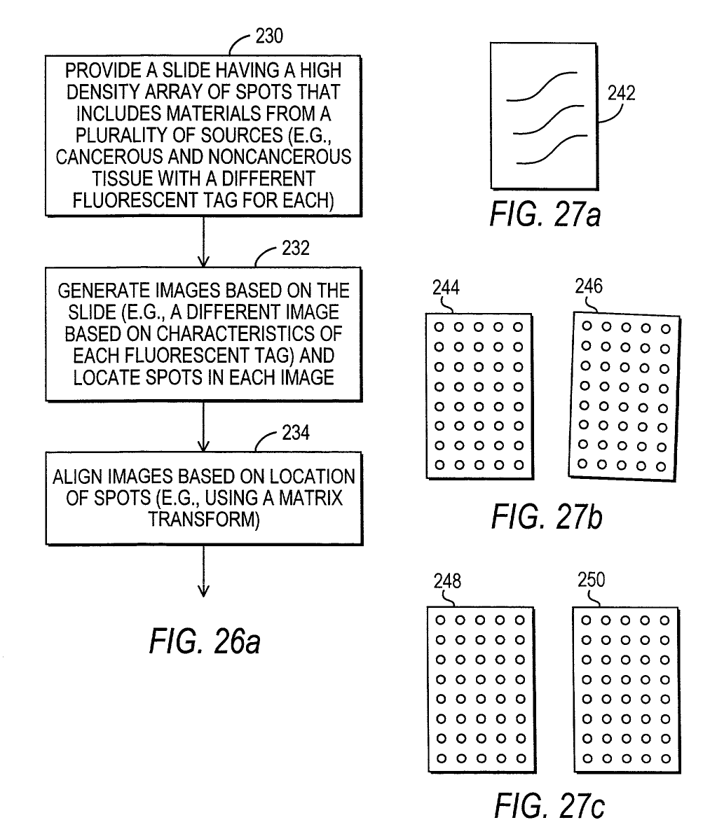

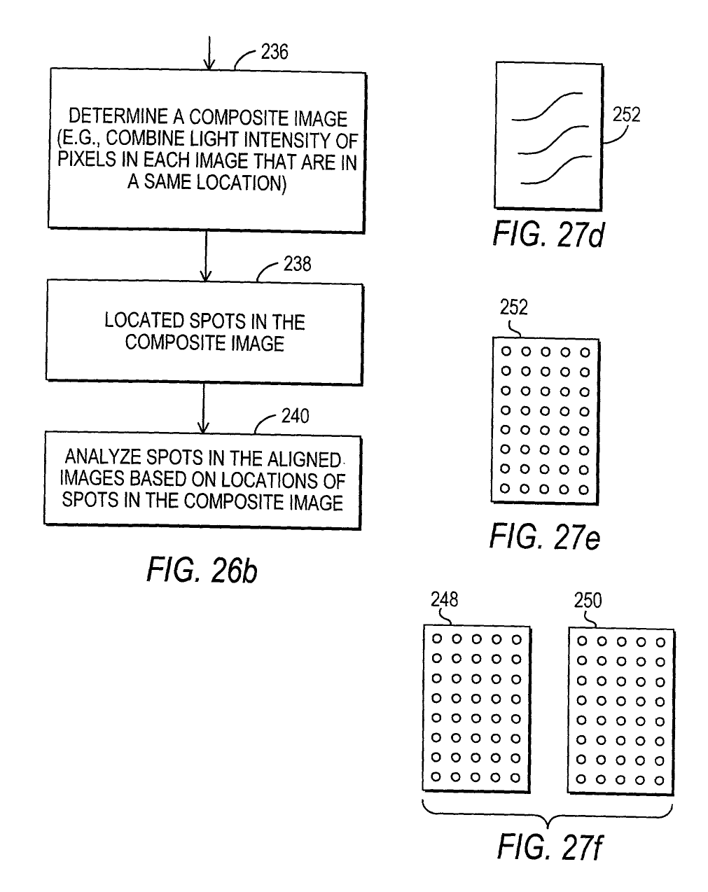

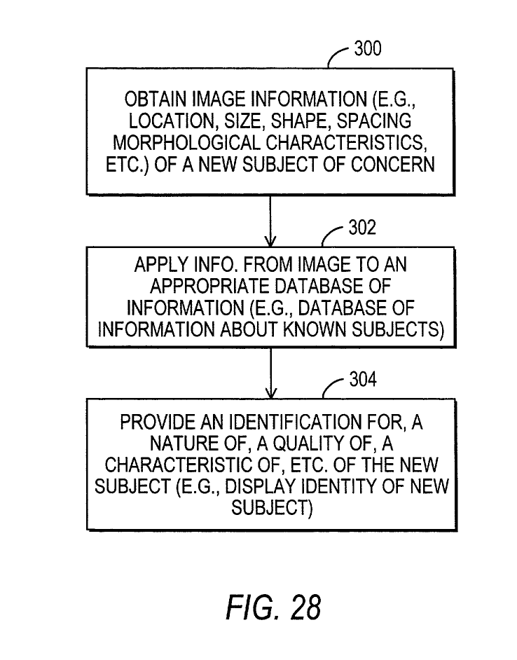

Illustrative steps involved in analysis of expression of spots from two source materials are shown in FIGS. 26a and 26b. FIGS. 27a-27f illustratively show spot analysis based on steps of FIGS. 26a and 26b.

At step 230, a slide (e.g., slide 242) may be provided that may have a high density array of spots that includes materials from a plurality of sources (e.g., spots either include cancerous or noncancerous tissue with a different fluorescent tag being used for each tissue type). At step 232, a plurality of images may be generated based on the slide, for example, one image (e.g., image 299) may be generated based on the characteristics of the fluorescent tag for one material tissue and another image (e.g., image 246) may be generated based on the characteristics of the fluorescent tag for the other material. Locations of spots in the images may be determined at step 232. At step 234, images (e.g., images 244 and 246) may be aligned to provide aligned images (e.g., image 248 and 259). To align images, one image may be selected as a reference image and the other image may be aligned to the reference image (e.g., using matrix transformation).

Images may be aligned using matrix transformation techniques. A reference image may be selected and other images of about the same size as the reference image may be aligned to the reference image using matrix transformation techniques. A transformation matrix may have the following form:

$$( \begin{matrix}{r}_{u} \\ {c}_{u}\end{matrix} ) = ( \begin{matrix}a & b \\ c & d\end{matrix} ) ( \begin{matrix}{r}_{r} \\ {c}_{r}\end{matrix} ) + ( \begin{matrix}e \\ f\end{matrix} ) .$$

Variables r and c may be row and column positions in pixels of an image. Subscript r may indicate reference image and subscript u may indicate unaligned image. The terms a, b, c, d, e, and f may represent coefficients. Positions of spots in the images that may have been determined using, for example, integration techniques, may be used to compute coefficients a, b, c, d, e, and f. A least squares process may be used to determine coefficients. The square of the distance between the actual position of a spot on an unaligned image (rᵤ, cᵤ) and aligned position (rᵤ*, cᵤ*), where (rᵤ*, cᵤ*) is calculated with the transformation matrix using the position of the same spot on the reference image (rᵣ, cᵣ), may be the following:

d²=(r*ᵤ−rᵤ)²+(C*ᵤ−Cᵤ)².

Substitution of the matrix transformation for (rᵤ*, cᵤ*) may give the following:

$$\begin{matrix}\begin{matrix}\begin{matrix}{d}^{2} = {a}^{2} {r}_{r}^{2} + {c}^{2} {r}_{r}^{2} + {abr}_{rCr} + 2 {cdr}_{r} {C}_{r} + 2 {aer}_{r} + \\ 2 {cfr}_{r} 2 {ar}_{r} {r}_{u} 2 {Cr}_{r} {C}_{u} + {b}^{2} {c}_{r}^{2} + {d}^{2} {c}_{r}^{2} + 2 {bec}_{r} +\end{matrix} \\ 2 {dfc}_{r} - 2 {bc}_{r} {r}_{u} - 2 d {c}_{r} {c}_{u} - 2 {cr}_{u} - 2 {fc}_{u} +\end{matrix} \\ {e}^{2} + {f}^{2} + {r}_{u}^{2} + {c}_{u}^{2} .\end{matrix}$$

The sum of the square of the distance for all spots may be minimized in terms of the coefficients. Performing this minimization may give the following two sets of linear equations that may be used to obtain a, b, c, d, e, and f.

$$\begin{matrix}( \begin{matrix}⟨ {r}_{r} ⟩ & ⟨ {c}_{r} ⟩ & I \\ ⟨ {r}_{r}^{2} ⟩ & ⟨ {r}_{r} {c}_{r} ⟩ & ⟨ {r}_{r} ⟩ \\ ⟨ {r}_{r} {c}_{r} ⟩ & ⟨ {c}_{r}^{2} ⟩ & ⟨ {c}_{r} ⟩\end{matrix} ) ( \begin{matrix}a \\ b \\ e\end{matrix} ) = ( \begin{matrix}⟨ {r}_{u} ⟩ \\ ⟨ {r}_{r} {r}_{u} ⟩ \\ ⟨ {c}_{r} {r}_{u} ⟩\end{matrix} ) \\ and \\ ( \begin{matrix}⟨ {r}_{r} ⟩ & ⟨ {c}_{r} ⟩ & I \\ ⟨ {r}_{r}^{2} ⟩ & ⟨ {r}_{r} {c}_{r} ⟩ & ⟨ {r}_{r} ⟩ \\ ⟨ {r}_{r} {c}_{r} ⟩ & ⟨ {c}_{r}^{2} ⟩ & ⟨ {c}_{r} ⟩\end{matrix} ) ( \begin{matrix}c \\ d \\ f\end{matrix} ) = ( \begin{matrix}⟨ {c}_{u} ⟩ \\ ⟨ {r}_{r} {c}_{u} ⟩ \\ ⟨ {c}_{r} {c}_{u} ⟩\end{matrix} ) \\ □\end{matrix}$$

The notation <x> refers to the averages of the quantity “x.” Thus, <rᵣ> may denote the average over all spots of the row position on the reference image. The term <rᵣcᵤ> may denote the average over all spots of the row position on the reference image multiplied by the column position on the unaligned image for the same spot.

An aligned image may be determined when the matrix transformation coefficients (a, b, c, d, e, and f) that relate an unaligned image to the reference image have been determined. The aligned image may have approximately the same size as the reference image. For each pixel in an aligned image, a corresponding position on the unaligned image may be determined. The intensity at the determined position on the unaligned image may be transferred to the corresponding position on the aligned image. Transferring intensities may involve interpolation of pixel intensities or direct transfer of intensities. Alignment techniques may be performed once per image. Alignment of the reference image may be excluded. If desired, alignment techniques, such as spot-by-spot alignment by minimization of a standard deviation of the logarithm of the ratio of intensities, may be used or may be used after matrix transformation techniques.

At step 236, a composite image (e.g., image 252) may be determined. A composite image may be determined by combining intensities of pixels in each aligned image that are approximately in the same location. At step 238, spots in the composite image may be located (e.g., by using thresholding techniques, integration techniques, etc.). At step 240, aligned images (e.g., images 248 and 250) may be analyzed based on locations of spots that were determined in the composite image.

A composite image may have been formed and locations of spots in the image may be identified to guarantee that data from image analysis of the aligned images are from the same pixels in each image. Data about the spots in the aligned images may be generated to analyze the different root sources that were placed on the slides.

With reference now to FIG. 28, at step 300, image information may be obtained based on the techniques and systems discussed herein. Image information may be obtained to determine information about a new subject of concern. Image information may be obtained using techniques such as, thresholding, integration, masking, mapping, etc. Image information may include morphological properties, location(s), size, shape, spacing, etc. Image information may be obtained for the new subject in a variety of technical fields. Image information may be obtained for high density arrays, radar images, target identification, machine movement control, differential expression of DNA, absolute expression of DNA, etc.

At step 302, image information may be applied to an appropriate database of information. The database may be appropriate for the technical field or appropriate for that type of subject. For example, the database may include information about known differential expressions of different cancers, known absolute expressions of DNA, known physical characteristics of different objects under radar, known physical characteristics of targets, etc. The database may include information that may be applied to the image information of the new subject.

At step 304, the new subject may be identified or a nature, quality, or characteristic of the new subject may be identified based on the image information being applied to the database information. For example, the type of cancer may be identified, a birth defect may be identified (e.g., when using absolute expressions), a type of airplane may be identified, a shape of an airplane may be identified, a particular direction for machine movement may be identified, etc. The identification or identity information may be displayed for use in the particular technical field that is involved.

Examples of such applications may involve medical testing of patients. For example, cancerous and noncancerous cells may be extracted from patient. The cells may be placed on a slide in a high density array of spots and hybridized to obtain differential expression of the cells. Image information about the spots may be obtained based on the techniques discussed herein. The image information may be applied to a database that includes information about differential expression characteristics of different types of cancer. The identify of the type of cancer may be provided based on the image and database information. As discussed above, these techniques may be provided for other technical effects such as when using absolute expressions of DNA, using radar image information to identify objects, etc.

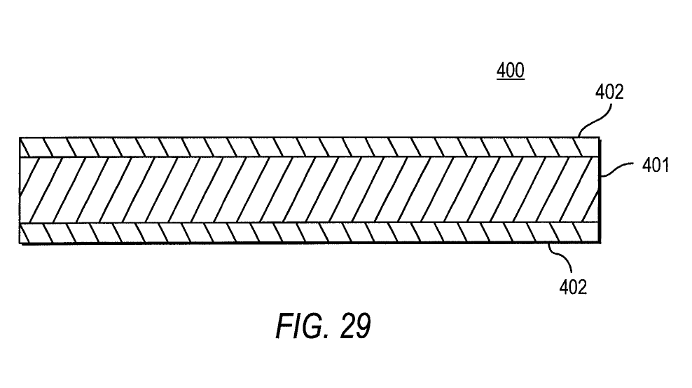

FIG. 29 presents a cross-section of a magnetic data storage medium 400 which can be encoded with a machine executable program that can be carried out by equipment such as equipment 20 of FIG. 1 to implement methods discussed in connection with FIGS. 2-27. Medium 400 may be the storage device of equipment 20 of FIG. 2. Medium 400 can be floppy diskette or hard disk, having a suitable substrate 401, which may be conventional, and a suitable coating 402, which may be conventional, on one or both sides, containing magnetic domains (not visible) whose polarity or orientation can be altered magnetically. Medium 400 may also have an opening (not shown) for receiving the spindle of a disk drive or other data storage device.

The magnetic domains of coating 402 of medium 400 are polarized or oriented so as to encode, in manner which may be conventional, a machine-executable program such as those described above in connection with FIGS. 2-28, for execution by equipment such as equipment 20 of FIG. 1.

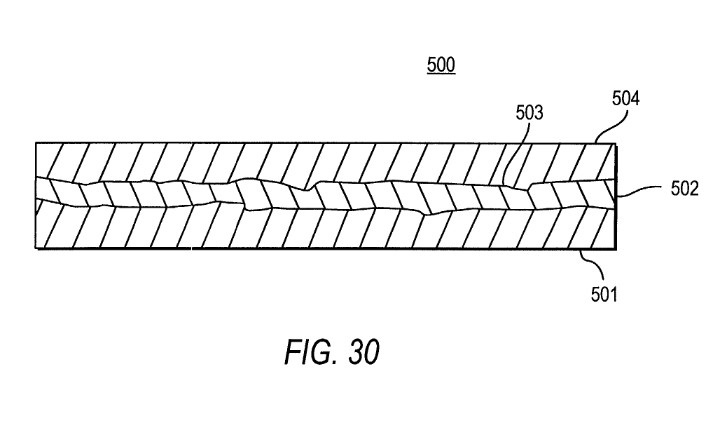

FIG. 30 shows a cross-section of an optically-readable data storage medium 500 which also can be encoded with such a machine-executable program, which can be carried out by equipment such as equipment 100 of FIG. 1. Medium 500 can be a conventional compact disk read only memory (CD-ROM) or a rewritable medium such as a CD-R or CD-RW disk or a magneto-optical disk which is optically readable and magneto-optically writeable. Medium 500 preferably has a suitable substrate 501, which may be conventional, and a suitable coating 502, which may be conventional, usually on one side of substrate 501.

In the case of a CD-ROM, as is well known, coating 502 is reflective and is impressed with a plurality of pits 503 to encode the machine-executable program. The arrangement of pits is read by reflecting laser light off the surface of coating 502. A protective coating 504, which preferably is substantially transparent, is provided on top of coating 502.

In the case of magneto-optical disk, as is well known, coating 502 has no pits 503, but has a plurality of magnetic domains whose polarity or orientation can be changed magnetically when heated above a certain temperature, as by a laser (not shown). The orientation of the domains can be read by measuring the polarization of laser light reflected from coating 502. The arrangement of the domains encodes the program as described above.

Thus, spot analysis may be accomplished automatically by locating spots in high density array of spots, mapping spots to printing pins used to furnish high density arrays, determining quantitative characteristics of spots in a high density array, etc. Such technique (e.g., thresholding, integration, mapping, filtering, etc.) may provide an appropriate balance between accuracy, speed of performance, complexity, processing demands, and storage requirements. With unlimited, processing speed and storage capability, highly complex techniques may be performed at high speeds to provide precise results. The techniques discussed herein, however, have been determined to provide appropriate precision without undue complexity or without an inappropriate drain on processing or storage capabilities.

The foregoing is merely illustrative of the principles of this invention and various modifications can be made by those skilled in the art without departing from the scope and spirit of the invention.

What is claimed is:

1. A method for automatically locating spots in an image based on intensities of points in the image, comprising:
determining whether a current point in the image and two adjacent points have intensities that are approximately above a minimum threshold intensity; and
identifying whether part of a new spot is located at the current point based only on the intensities of the two adjacent points when the current point has an intensity that is approximately above the minimum threshold intensity.

2. The method of claim 1 wherein said determining comprises determining whether the current point and the two adjacent points have intensities that are approximately within a threshold range comprising the minimum threshold intensity and a maximum threshold intensity.

3. The method of claim 1 wherein said identifying comprises identifying based only on the two adjacent points when the current point is approximately within the threshold range.

4. The method of claim 1 further comprising providing a plurality of pixels that are representative of the points in the image.

5. The method of claim 4 wherein said determining and said identifying comprises using a current pixel that corresponds to the current point and two of the pixels that are adjacent to the current pixel which correspond to the two adjacent points in said determining and said identifying.

6. The method of claim 5 wherein,
said determining comprises determining whether the current pixel and the two adjacent pixels have intensities that are approximately within a threshold range comprising the minimum threshold intensity and a maximum threshold intensity; and
said identifying comprises identifying when the current pixel has intensity that is approximately within the threshold range.

7. The method of claim 5 further comprising repeating said determining to evaluate the plurality of pixels by walking through the image pixel-by-pixel in lines of pixels.

8. A method of automatically locating spots in an image based on intensities of pixels in the image, comprising:
determining whether a current pixel in the image and two pixels adjacent to the current pixel have intensities that are approximately within a threshold range;
identifying whether part of a new spot is located at the current pixel based only on the intensities of the two adjacent pixels when the current pixel has an intensity that is approximately within the threshold range; and
repeating said determining and said identifying to identify a high density array of spots.

9. The method of claim 8 wherein said identifying comprises identifying the current pixel to be part of a known spot when the two adjacent pixels have been identified to be part of that known spot.

10. The method of claim 8 wherein said identifying comprises identifying the current pixel to be part of a known spot when one of the two adjacent pixels has been identified to be part of the known spot and the intensity of the other one of the two adjacent pixels has been determined to be approximately outside the threshold range.

11. The method of claim 8 further comprising determining which ones of the other pixels are part of the new spot.

12. The method of claim 11 comprising
determining whether any of the pixels that are determined to be part of the new spot are located at the edge of the image; and
rejecting the new spot in response to determining that the pixels in the new spot are located approximately at the edge of the image.

13. The method of claim 11 further comprising determining that a particular pixel in the image is part of the new spot based on that particular pixel being substantially enclosed by some of the pixels that have been determined to be part of the new spot.

14. The method of claim 8 further comprising identifying where another spot is located in the image based on determining an integrated intensity for a region that is centered on another one of the pixels.

15. A method for automatically locating spots in an image based on intensities of pixels in the image, comprising:
searching for a first pixel that has an intensity that is approximately above a threshold intensity;
determining that a part of a new spot is located at the first pixel in response to said searching;
searching only nearest neighbors recursively starting from the first pixel to identify which ones of the pixels in the image are part of the new spot based on the threshold intensity; and
repeating said searching for a first pixel, said determining, and said searching to identify a high density array of spots in the image.

16. The method of claim 15 wherein said searching recursively comprises searching only nearest neighbors recursively starting from every pixel that is identified to be part of the new spot to identify which other ones of the pixels in the image are part of that new spot.

17. The method of claim 15 wherein said searching for the first pixel comprises searching serially pixel-by-pixel in lines of pixels.

18. The method of claim 15 wherein said searching recursively comprises searching recursively until substantially all of the pixels that are contiguous with the first pixel and that have intensities that are approximately above the threshold intensity are identified.

19. The method of claim 18 further comprising repeating said searching for a first pixel to locate another spot in response to identifying substantially all of the pixels that are part of the new spot.

20. A method for automatically locating spots in an image based on intensities of pixels in the image, comprising:
searching serially for a first pixel that has an intensity that is approximately above a threshold intensity;
determining that part of a new spot is located at the first pixel in response to said searching; and
searching only nearest neighbors recursively starting from the first pixel to identify which ones of the pixels in the image are part of the new spot based on the threshold intensity.

21. The method of claim 20 wherein said searching serially and said searching only nearest neighbors includes searching each pixel in the image at most once.

22. The method of claim 20 further comprising determining whether one of the pixels that are identified to be part of the new spot are located approximately at an edge of the image.

23. The method of claim 20 further comprising determining that a particular pixel is part of the new spot based on that particular pixel being substantially enclosed by some of the pixels that are identified to be part of the new spot.

24. The method of claim 20 further comprising determining where another spot is located based on determining an integrated intensity for a region in the image that is centered on another one of the pixels.

25. A method for automatically locating spots in an image based on intensities of pixels in the image, comprising:
determining an integrated intensity for each of a plurality of particularly-shaped regions that are each centered on a different one of a plurality of pixels in the image; and
identifying that a new spot is located in one of the regions based on the integrated intensity of that region in relation to the integrated intensities of the other regions.

26. The method of claim 25 wherein said determining comprises providing each of the regions to be approximately the size of a spot pitch for a plurality of spots that are in the image.

27. The method of claim 25 wherein said determining comprises masking each region before determining the integrated intensity.

28. The method of claim 27 wherein said masking comprises masking to sharpen spot characteristics.

29. The method of claim 25 wherein said determining comprises determining which one of the regions has a highest integrated intensity in relation to the rest of the regions to identify which one of the regions includes a new spot.

30. A method for automatically locating spots in an image based on intensities of pixels in the image, comprising:
determining an integrated intensity for a plurality of particularly-shaped regions that are each centered on a different one of a plurality of pixels in the image;
determining which one of the regions has a highest integrated intensity in relation to the rest of the regions to identify which one of the regions includes a new spot; and
setting any of the regions that overlap the region having the highest integrated intensity to have a lowest integrated intensity.

31. The method of claim 30 further comprising determining that a second spot is located in a next region having the next highest integrated intensity in relation to the other regions.

32. The method of claim 30 further comprising determining a center point for the new spot based on a threshold intensity that is determined from the intensities of the pixels in the region in which the new spot was identified to be located.

33. The method of claim 30 wherein said determining which one comprises identifying that one of the regions includes the new spot based on characteristics of pixels that are in that region that are determined based on a threshold intensity.

34. The method of claim 30 further comprising determining a location for another spot based on a threshold intensity.

35. A method for relating a plurality of spots that have been placed on a slide to a grid comprising grid points that were used in placing the spots on the slide, comprising:
providing an image that is representative of the slide;
determining where the spots are located in the image;
mapping the grid on to the image using a plurality of test locations on the image as origins for the grid to determine a best origin for the grid in relation to the spots; and
assigning each spot to one of the grid points in the grid based on evaluating which grid point is nearest to the location of that spot.

36. The method of claim 35 wherein said providing comprises generating the image using a plurality of pixels that are each representative of approximately one of a plurality of points on the slide based on an intensity of the point that each pixel represents.

37. The method of claim 36 wherein said mapping comprises selecting one of the test locations to be the best origin based on a total intensity for pixels that are approximately within a selected distance from each grid point.

38. The method of claim 36 further comprising selecting one of the test locations to be the best origin based on a total distance between every one of the grid points and the spot nearest to that grid point.

39. The method of claim 35 further comprising determining a positional relationship of the grid points to each other based a spot pitch, pin pitch, number of rows and columns of spots, and number of rows and columns of printer pins of a spot printer that was used to place the spots on the slide.

40. The method of claim 35 further comprising determining an actual spot pitch based on where spots are located in the image.

41. The method of claim 40 wherein said mapping further comprises adjusting the shape of the grid based on the actual spot pitch.

42. The method of claim 40 wherein said determining an actual spot pitch comprises determining a directional spot pitch vector by averaging vectors for pairs of nearest neighboring spots in approximately one direction.

43. The method of claim 40 wherein said determining an actual spot pitch comprises:
sorting the spots based on where they are located in the image;
selecting a plurality of pairs of spots based on the sorted list; and
determining a spot pitch vector by averaging vectors for the selected pairs of spots.

44. A method for using intensities of pixels in a current image having a plurality of spots to filter further images comprising:
identifying in a current image a plurality of similarly-shaped regions that each include one of the spots that each include a plurality of pixels; and
determining an average intensity profile for the regions based on averaging intensities for the pixels that are approximately in the same location in each of the identified regions; and
filtering intensities in further images using the average intensity profile.

45. The method of claim 44 wherein said identifying comprises centering each of the regions over the spot that is in that region.

46. The method of claim 44 wherein said filtering comprises filtering using the average intensity profile to weigh pixels in further images that are to be analyzed.

47. The method of claim 44 further comprising identifying spot locations in the further images based on the filtered intensities.

48. A method for analyzing a plurality of spots that are placed on a slide to test expressions of a plurality of source materials in the spots based on a plurality of images that are each differently representative of the slide, wherein locations of the spots in the images have been determined, comprising:
determining an aligned image for each of a plurality of the images based on the locations of spots in one of the plurality of images in relation to the location of spots in each of the other images;
determining a composite image based on the aligned images;
determining which areas in the composite image comprises spots; and
analyzing areas in one of the aligned images for expressions of one of the source materials based on the areas that were determined to comprise spots in the composite image.

49. The method of claim 48 further comprising:
providing for each of the plurality of the images a plurality of pixels that are each representative of a point on the slide being represented by that image; and
wherein said determining an aligned image, comprises aligning the pixels to form the aligned image for each slide.

50. The method of claim 49 wherein said aligning comprises applying a matrix transform on a pixel-by-pixel basis to determine the aligned image for each slide.

51. The method of claim 49 wherein said determining an aligned image comprises:
selecting one of the images to be a reference image; and
aligning the other images to the selected reference image.

52. The method of claim 49 wherein said providing comprises:
providing each of the plurality of pixels to have an intensity of the point which that pixel represents; and
said determining a composite image, comprises combining light intensities for pixels that are approximately in a same location in each of the aligned images.

53. The method of claim 49 wherein said determining which areas, comprises determining which areas based on a threshold intensity for the pixels in the composite image.

54. The method of claim 49 wherein said determining which areas, comprises determining which areas based on an integrated intensity for each of a plurality of regions in the composite image.

55. A method for automatically determining where spots in an image are located based on intensities of a plurality of pixels in the image, comprising:
determining a threshold intensity for a particular image region based on intensities of a portion of the pixels in that region; and
determining whether one of the spots is at least partly located in the region based on the threshold intensity determined for that region.

56. The method of claim 55 wherein said determining a threshold intensity, comprises using the portion to be approximately a size of an average spot.

57. The method of claim 55 further comprising repeating for another region said determining a threshold intensity and said determining whether one of the spots to determine whether there are any spots in the other region.

58. The method of claim 57 wherein said repeating comprises selecting the other region based on a spot pitch for the spots in the slide and a current region.

59. The method of claim 55 wherein said determining whether one of the spots, comprises determining whether one of the spots is at least partly in the region based on characteristics of a group of the pixels in the particular region.

60. The method of claim 55 further comprising:
determining that one of the spots is at least partly in the region;
determining which ones of the pixels in that region are part of the spot that is at least partly in that region;
determining a center pixel for the pixels that have been determined to be in that spot; and
moving the region to be centered on the center pixel and repeating said determining threshold intensity and said determining whether one of the spots.

61. A method for automatically locating spots in an image based on intensities of pixels in the image comprising:
determining an integrated intensity for each of a plurality of regions in the image;
sorting the integrated intensities in the regions in descending order; and
claiming some of the regions to contain spots based on determining the highest integrated intensity among the regions while setting the integrated intensities for the regions that overlap the claimed regions to be a lowest integrated intensity.

62. The method of claim 61 wherein said claiming comprises setting overlapping regions to zero.

63. The method of claim 61 wherein said determining comprises masking the regions when determining the integrating intensity in each one of the regions.

64. The method of claim 61 further comprising providing the regions to be approximately the size of a spot pitch for the spots in the image.

65. A machine-readable storage medium encoded with a set of machine executable instructions for using image analysis equipment to perform a method for automatically locating spots in an image based on intensities of points in the image, comprising:
determining whether a current point in the image and two adjacent points have intensities that are approximately above a minimum threshold intensity; and
identifying whether part of a new spot is located at the current point based only on the intensities of the two adjacent points when the current point has an intensity that is approximately above the minimum threshold intensity.

66. The machine-readable storage medium of claim 65 wherein said determining in said method comprises determining whether the current point and the two adjacent points have intensities that are approximately within a threshold range comprising the minimum threshold intensity and a maximum threshold intensity.

67. The machine-readable storage medium of claim 65 wherein said identifying in said method comprises identifying based only on the two adjacent points when the current point is approximately within the threshold range.

68. The machine-readable storage medium of claim 65 wherein said method further comprising providing a plurality of pixels that are representative of the points in the image.

69. The machine-readable storage medium of claim 68 wherein said determining and said identifying in said method comprises using a current pixel that corresponds to the current point and two of the pixels that are adjacent to the current pixel which correspond to the two adjacent points in said determining and said identifying.

70. The machine-readable storage medium of claim 69 wherein,
said determining in said method comprises determining whether the current pixel and the two adjacent pixels have intensities that are approximately within a threshold range comprising the minimum threshold intensity and a maximum threshold intensity; and
said identifying in said method comprises identifying when the current pixel has intensity that is approximately within the threshold range.

71. The machine-readable storage medium of claim 69 wherein said method further comprising repeating said determining to evaluate the plurality of pixels by walking through the image pixel-by-pixel in lines of pixels.

72. A machine-readable storage medium encoded with a set of machine executable instructions for using image analysis equipment to perform a method of automatically locating spots in an image based on intensities of pixels in the image, comprising:
determining whether a current pixel in the image and two pixels adjacent to the current pixel have intensities that are approximately within a threshold range;
identifying whether part of a new spot that is located at the current pixel based only on the intensities of the two adjacent pixels when the current pixel has an intensity that is approximately within the threshold range; and
repeating said determining and said identifying to identify a high density array of spots.

73. The machine-readable storage medium of claim 72 wherein said identifying in said method comprises identifying the current pixel to be part of a known spot when the two adjacent pixels have been identified to be part of that known spot.

74. The machine-readable storage medium of claim 72 wherein said identifying in said method comprises identifying the current pixel to be part of a known spot when one of the two adjacent pixels has been identified to be part of the known spot and the intensity of the other one of the two adjacent pixels has been determined to be approximately outside the threshold range.

75. The machine-readable storage medium of claim 74 wherein said method further comprising determining which ones of the other pixels are part of the new spot.

76. The machine-readable storage medium of claim 75 wherein said method comprising:
determining whether any of the pixels that are determined to be part of the new spot are located at the edge of the image; and
rejecting the new spot in response to determining that the pixels in the new spot are located approximately at the edge of the image.

77. The machine-readable storage medium of claim 75 wherein said method further comprising determining that a particular pixel in the image is part of the new spot based on that particular pixel being substantially enclosed by some of the pixels that have been determined to be part of the new spot.

78. The machine-readable storage medium of claim 72 wherein said method further comprising identifying where another spot is located in the image based on determining an integrated intensity for a region that is centered on another one of the pixels.

79. A machine-readable storage medium encoded with a set of machine executable instructions for using image analysis equipment to perform a method for automatically locating spots in an image based on intensities of pixels in the image, comprising:
searching for a first pixel that has an intensity that is approximately above a threshold intensity;
determining that a part of a new spot is located at the first pixel in response to said searching;
searching only nearest neighbors recursively starting from the first pixel to identify which ones of the pixels in the image are part of the new spot based on the threshold intensity; and
repeating said searching for a first pixel, said determining, and said searching to identify a high density array of spots in the image.

80. The machine-readable storage medium of claim 79 wherein said searching only nearest neighbors recursively comprises searching recursively starting from every pixel that is identified to be part of the new spot to identify which ones of the pixels in the image are part of that new spot.

81. The machine-readable storage medium of claim 79 wherein said searching for the first pixel comprises searching serially pixel-by-pixel in lines of pixels.

82. The machine-readable storage medium of claim 79 wherein said searching recursively comprises searching recursively until substantially all of the pixels that are contiguous with the first pixel and that have intensities that are approximately above the threshold intensity are identified.

83. The machine-readable storage medium of claim 82 wherein said method further comprising repeating said searching for a first pixel to locate another spot in response to identifying substantially all of the pixels that are part of the new spot.

84. A machine-readable storage medium encoded with a set of machine executable instructions for using image analysis equipment to perform a method for automatically locating spots in an image based on intensities of pixels in the image, comprising:
searching serially for a first pixel that has an intensity that is approximately above a threshold intensity;
determining that part of a new spot is located at the first pixel in response to said searching; and
searching only nearest neighbors recursively starting from the first pixel to identify which ones of the pixels in the image are part of the new spot based on the threshold intensity.

85. The machine-readable storage medium of claim 84 wherein said searching serially and said searching only nearest neighbors includes searching each pixel in the image at most once.

86. The machine-readable storage medium of claim 84 wherein said method further comprising determining whether one of the pixels that are identified to be part of the new spot are located approximately at an edge of the image.

87. The machine-readable storage medium of claim 84 wherein said method further comprising determining that a particular pixel is part of the new spot based on that particular pixel being substantially enclosed by some of the pixels that are identified to be part of the new spot.

88. The machine-readable storage medium of claim 84 wherein said method further comprising determining where another spot is located based on determining an integrated intensity for a region in the image that is centered on another one of the pixels.

89. A machine-readable storage medium encoded with a set of machine executable instructions for using image analysis equipment to perform a method for automatically locating spots in an image based on intensities of pixels in the image, comprising:
determining an integrated intensity for each of a plurality of particularly-shaped regions that are each centered on one of a plurality of pixels in the image; and
identifying that a new spot is located in one of the regions based on the integrated intensity of that region in relation to the integrated intensities of the other regions.

90. The machine-readable storage medium of claim 89 wherein said determining comprises providing each of the regions to be approximately the size of a spot pitch for a plurality of spots that are in the image.

91. The machine-readable storage medium of claim 89 wherein said determining comprises masking each region before determining the integrated intensity.

92. The machine-readable storage medium of claim 91 wherein said masking comprises masking to sharpen spot characteristics.

93. The machine-readable storage medium of claim 89 wherein said determining comprises determining which one of the regions has a highest integrated intensity in relation to the rest of the regions to identify which one of the regions includes a new spot.

94. A machine-readable storage medium encoded with a set of machine executable instructions for using image analysis equipment to perform a method for automatically locating spots in an image based on intensities of pixels in the image, comprising:
determining an integrated intensity for a plurality of particularly-shaped regions that are each centered on one of a plurality of pixels in the image;
determining which one of the regions has a highest integrated intensity in relation to the rest of the regions to identify which one of the regions includes a new spot; and
setting any of the regions that overlap the region having the highest integrated intensity to have a lowest integrated intensity.

95. The machine-readable storage medium of claim 94 wherein said method further comprising determining that a second spot is located in a next region having the next highest integrated intensity in relation to the other regions.

96. The machine-readable storage medium of claim 94 wherein said method further comprising determining a center point for the new spot based on a threshold intensity that is determined from the intensities of the pixels in the region in which the new spot was identified to be located.

97. The machine-readable storage medium of claim 94 wherein said determining which one comprises identifying that one of the regions includes the new spot based on characteristics of pixels that are in that region that are determined based on a threshold intensity.

98. The machine-readable storage medium of claim 94 wherein said method further comprising determining a location for another spot based on a threshold intensity.

99. A machine-readable storage medium encoded with a set of machine executable instructions for using image analysis equipment to perform a method for relating a plurality of spots that have been placed on a slide to a grid comprising grid points that were used in placing the spots on the slide, comprising:
providing an image that is representative of the slide;
determining where the spots are located in the image;
mapping the grid on to the image using a plurality of test locations on the image as origins for the grid to determine a best origin for the grid in relation to the spots; and
assigning each spot to one of the grid points in the grid based on evaluating which grid point is nearest to the location of that spot.

100. The machine-readable storage medium of claim 99 wherein said providing comprises generating the image using a plurality of pixels that are each representative of approximately one of a plurality of points on the slide based on an intensity of the point that each pixel represents.

101. The machine-readable storage medium of claim 100 wherein said mapping comprises selecting one of the test locations to be the best origin based on a total intensity for pixels that are approximately within a selected distance from each grid point.

102. The machine-readable storage medium of claim 100 wherein said method further comprising selecting one of the test locations to be the best origin based on a total distance between every one of the grid points and the spot nearest to that grid point.

103. The machine-readable storage medium of claim 99 wherein said method further comprising determining a positional relationship of the grid points to each other based a spot pitch, pin pitch, number of rows and columns of spots, and number of rows and columns of printer pins of a spot printer that was used to place the spots on the slide.

104. The machine-readable storage medium of claim 99 wherein said method further comprising determining an actual spot pitch based on where spots are located in the image.

105. The machine-readable storage medium of claim 104 wherein said mapping further comprises adjusting the shape of the grid based on the actual spot pitch.

106. The machine-readable storage medium of claim 104 wherein said determining an actual spot pitch comprises determining a directional spot pitch vector by averaging vectors for pairs of nearest neighboring spots in approximately one direction.

107. The machine-readable storage medium of claim 104 wherein said determining an actual spot pitch comprises:
sorting the spots based on where they are located in the image;
selecting a plurality of pairs of spots based on the sorted list; and
determining a spot pitch vector by averaging vectors for the selected pairs of spots.

108. A machine-readable storage medium encoded with a set of machine executable instructions for using image analysis equipment to perform a method for using intensities of pixels in a current image having a plurality of spots to filter further images comprising:
identifying in a current image a plurality of similarly-shaped regions that each include one of the spots that each include a plurality of pixels; and
determining an average intensity profile for the regions based on averaging intensities for the pixels that are approximately in the same location in each of the identified regions; and
filtering intensities in further images using the average intensity profile.

109. The machine-readable storage medium of claim 108 wherein said identifying comprises centering each of the regions over the spot that is in that region.

110. The machine-readable storage medium of claim 108 wherein said filtering comprises filtering using the average intensity profile to weigh pixels in further images that are to be analyzed.

111. The machine-readable storage medium of claim 108 further comprising identifying spot locations in the further images based on the filtered intensities.

112. A machine-readable storage medium encoded with a set of machine executable instructions for using image analysis equipment to perform a method for analyzing a plurality of spots that are placed on a slide to test expressions of a plurality of source materials in the spots based on a plurality of images that are each differently representative of the slide, wherein locations of the spots in the images have been determined, comprising:
determining an aligned image for each of a plurality of the images based on the locations of spots in one of the plurality of images in relation to the location of spots in each of the other images;
determining a composite image based on the aligned images;
determining which areas in the composite image comprises spots; and
analyzing areas in one of the aligned images for expressions of one of the source materials based on the areas that were determined to comprise spots in the composite image.

113. The machine-readable storage medium of claim 112 wherein said method further comprising:
providing for each of the plurality of the images a plurality of pixels that are each representative of a point on the slide being represented by that image; and
wherein said determining an aligned image, comprises aligning the pixels to form the aligned image for each slide.

114. The machine-readable storage medium of claim 113 wherein said aligning comprises applying a matrix transform on a pixel-by-pixel basis to determine the aligned image for each slide.

115. The machine-readable storage medium of claim 113 wherein said determining an aligned image comprises:
selecting one of the images to be a reference image; and
aligning the other images to the selected reference image.

116. The machine-readable storage medium of claim 113 wherein said providing comprises:
providing each of the plurality of pixels to have an intensity of the point which that pixel represents; and
said determining a composite image, comprises combining light intensities for pixels that are approximately in a same location in each of the aligned images.

117. The machine-readable storage medium of claim 113 wherein said determining which areas, comprises determining which areas based on a threshold intensity for the pixels in the composite image.

118. The machine-readable storage medium of claim 113 wherein said determining which areas, comprises determining which areas based on an integrated intensity for each of a plurality of regions in the composite image.

119. A machine-readable storage medium encoded with a set of machine executable instructions for using image analysis equipment to perform a method for automatically determining where spots in an image are located based on intensities of a plurality of pixels in the image, comprising:
determining a threshold intensity for a particular image region based on intensities of a portion of the pixels in that region; and
determining whether one of the spots is at least partly located in the region based on the threshold intensity determined for that region.

120. The machine-readable storage medium of claim 119 wherein said determining a threshold intensity, comprises using the portion to be approximately a size of an average spot.

121. The machine-readable storage medium of claim 119 wherein said method further comprising repeating for another region said determining a threshold intensity and said determining whether one of the spots to determine whether there are any spots in the other region.

122. The machine-readable storage medium of claim 121 wherein said repeating comprises selecting the other region based on a spot pitch for the spots in the slide and a current region.

123. The machine-readable storage medium of claim 119 wherein said determining whether one of the spots, comprises determining whether one of the spots is at least partly in the region based on characteristics of a group of the pixels in the particular region.

124. The machine-readable storage medium of claim 119 wherein said method further comprising:
determining that one of the spots is at least partly in the region;
determining which ones of the pixels in that region are part of the spot that is at least partly in that region;
determining a center pixel for the pixels that have been determined to be in that spot; and
moving the region to be centered on the center pixel and repeating said determining threshold intensity and said determining whether one of the spots.

125. A machine-readable storage medium encoded with a set of machine executable instructions for using image analysis equipment to perform a method for automatically locating spots in an image based on intensities of pixels in the image comprising:
determining an integrated intensity for each of a plurality of regions in the image;
sorting the integrated intensities in the regions in descending order; and
claiming some of the regions to contain spots based on determining the highest integrated intensity among the regions while setting the integrated intensities for the regions that overlap the claimed regions to be a lowest integrated intensity.

126. The machine-readable storage medium of claim 125 wherein said claiming comprises setting overlapping regions to zero.

127. The machine-readable storage medium of claim 125 wherein said determining comprises masking the regions when determining the integrating intensity in each one of the regions.

128. The machine-readable storage medium of claim 125 wherein said method further comprising providing the regions to be approximately the size of a spot pitch for the spots in the image.

129. A method of automatically locating objects in an image based on intensities of pixels in the image, comprising:
determining whether a current pixel in the image and two pixels adjacent to the current pixel have intensities that are approximately within a threshold range; and
identifying whether part of a new object is located at the current pixel based only on the intensities of the two adjacent pixels when the current pixel has an intensity that is approximately within the threshold range.

130. A method for automatically locating objects in an image based on intensities of pixels in the image, comprising:
searching for a first pixel that has an intensity that is approximately above a threshold intensity;
determining that a part of a new object is located at the first pixel in response to said searching; and
searching only nearest neighbors recursively starting from the first pixel to identify which ones of the pixels in the image are part of the new object based on the threshold intensity.

131. A method for automatically locating objects in an image based on intensities of pixels in the image, comprising:
determining an integrated intensity for each of a plurality of particularly-shaped regions that are each centered on a different one of a plurality of pixels in the image; and
identifying that a new object is located in one of the regions based on the integrated intensity of that region in relation to the integrated intensities of the other regions.

132. A method for automatically locating spots in an image based on intensities of pixels in the image, comprising:
determining an integrated intensity for each of a plurality of particularly-shaped regions that are each centered on a different one of a plurality of pixels in the image;
identifying that a new spot is located in one of the regions based on the integrated intensity of that region in relation to the integrated intensities of the other regions; and
repeating said determining and said identifying to identify a high density array of spots in that image.
